(19) United States
(12) Patent Application Publication
(10) Pub. No.: US 2025/0392052 A1
(43) Pub. Date: Dec. 25, 2025

(54) REFLECT ARRAY

(71) Applicant: Toppan Holdings Inc., Tokyo (JP)

(72) Inventors: Hiroyoshi NISHIYAMA, Tokyo (JP); Jumpei Imai, Tokyo (JP); Shinpei Kondo, Tokyo (JP); Daiki Nishimura, Tokyo (JP)

(73) Assignee: Toppan Holdings Inc., Tokyo (JP)

(21) Appl. No.: 19/314,429

(22) Filed: Aug. 29, 2025

Related U.S. Application Data
(63) Continuation of application No. PCT/JP2023/036300, filed on Oct. 5, 2023.

(30) Foreign Application Priority Data
Mar. 3, 2023 (JP) 2023-032778

(51) Int. Cl. H01Q 15/14

(52) U.S. Cl. CPC H01Q 15/14

(57) ABSTRACT

The present invention has been made to provide a thinner and lighter reflect array One of representative reflect arrays according to the present invention includes: a ground layer; a dielectric layer; and an element pattern layer having a plurality of element patterns, wherein a thickness t (mm), which is a thickness of the dielectric layer and an element length l (mm), which is a length of each of the plurality of element patterns, satisfy the following relational formula. The ground layer has a surface resistance of 100Ω/□ or less. At least one of the ground layer and the element pattern layer is made of Cu or Al.

### CROSS-REFERENCE TO RELATED PATENT APPLICATIONS

The present application is a U.S. Bypass Continuation of International Patent Application No. PCT/JP2023/036300, filed on Oct. 5, 2023, which claims priority to and the benefit of Japanese Patent Application No. 2023-032778, filed on Mar. 3, 2023. The contents of these applications are hereby incorporated by reference herein in their entireties.

### TECHNICAL FIELD

The present invention relates to reflect arrays that can reflect electromagnetic waves of a specific frequency.

### BACKGROUND

The fifth generation mobile communication system (5G) uses electromagnetic waves in the sub-6 band (3.6 GHz and above) and millimeter wave band (24 GHz and above), which are higher frequencies than for existing LTE (4G). While millimeter waves have a large information transmission capacity, they are characterized by high directivity of electromagnetic waves and short reach. Therefore, when electromagnetic waves in the millimeter wave band are used, there is a problem that electromagnetic waves are rapidly attenuated due to shielding by buildings or the like, resulting in “dead zones” where communication quality cannot be secured. This problem can be solved by adding more base stations and repeaters, but there are various hurdles such as cost and installation space.

Reflect arrays are reflectors with a special structure that can reflect electromagnetic waves of a specific frequency asymmetrically. Unlike metal reflectors that reflect electromagnetic waves specularly like a mirror, it is possible to freely design the frequency band to be reflected, the incidence direction and the reflection direction, or the spread of the reflected wave. These characteristics are expected to improve the electromagnetic wave situation in dead zones without the need for installing additional base stations.

In light of the above background, the development of reflect arrays is being actively pursued.

PTL 1 discloses a reflect array that reflects an incident wave in a desired direction, the reflect array including: a substrate having a surface perpendicular to a predetermined axis; and a plurality of elements provided on the substrate, wherein a specific element among the plurality of elements reflects the incident wave having a specific reflection phase among a plurality of reflection phases, each of the plurality of elements has an element structure including at least a patch and a ground plate, an element spacing of first neighboring elements is different from an element spacing of second neighboring elements, and a length of a gap between patches of the first neighboring elements is equal to a length of a gap between patches of the second neighboring elements.

2 discloses a repeater device including: a periodic array of alternating metallic phase-shifting elements, the array being periodic in at least one axis, formed on a first surface of a dielectric substrate, with an opposite surface of the dielectric substrate having a ground plane formed thereon, wherein each phase-shifting element provides from 0° to 360° phase-shifting in a microwave frequency range. The repeater device can be utilized in a microwave network.

PTL 3 discloses a metasurface reflector including: a dielectric substrate; a metal ground layer provided on a bottom of the dielectric substrate to prevent polarized waves in all directions from penetrating the metasurface reflector; and a plurality of supercells having two or more types of cruciform metal resonators having different arm lengths. The supercells having metal resonators are formed on the top of the dielectric substrate and arrayed with a periodicity of a diffraction grating that reflects vertically and horizontally polarized incident waves and anomalously reflects electromagnetic waves of a predetermined frequency at the required phase.

### CITATION LIST

### Patent Literature

PTL 1: JP 5410558 B PTL 2: JP 7026124 B PTL 3: JP 2021-048465 A

### SUMMARY OF THE INVENTION

### Technical Problem

Making reflect arrays thinner and lighter has many advantages in production and installation, but has not been fully considered in any of the prior art.

Therefore, the present invention has been made to provide thinner and lighter reflect arrays.

### Solution to Problems

In light of the above circumstances, one of representative reflect arrays according to the present invention includes: a ground layer; a dielectric layer; and an element pattern layer having a plurality of element patterns, wherein a thickness t (mm), which is a thickness of the dielectric layer and an element length 1 (mm), which is a length of each of the plurality of element patterns, satisfy the following relational formula:

$$\begin{matrix}[ Math . 1 ] & \\ 1 \geq 4.4 \times t and 0.001 < t < 0.25 & ( 6 )\end{matrix}$$

### Advantageous Effects of Invention

According to the present invention, it is possible to provide a thinner and lighter reflect array.

Problems, configurations and effects other than those described above will be apparent from the description of embodiments below.

### BRIEF DESCRIPTION OF THE DRAWINGS

FIG. 1 is a cross-sectional view of a reflect array according to a first embodiment.

FIG. 2 is a diagram schematically illustrating a part of a reflect array.

FIG. 3 is a diagram illustrating a cruciform element pattern.

FIG. 4 is a diagram illustrating an example of the results of a simulation performed on a reflection control region.

FIG. 5 is a cross-sectional view of a reflect array according to a modified example of the first embodiment.

FIGS. 6A-6C are a cross-sectional view of a reflect array according to a second embodiment.

FIGS. 7A and 7B are a cross-sectional view of a reflect array according to the second embodiment.

FIGS. 8A-8C are a cross-sectional view of a reflect array according to a third embodiment.

FIGS. 9A and 9B are a cross-sectional view of a reflect array according to the third embodiment.

FIGS. 10A-10C are a cross-sectional view of a reflect array according to the third embodiment.

FIGS. 11A-11C are a cross-sectional view of a reflect array according to the third embodiment.

FIGS. 12A-12C are a cross-sectional view of a reflect array according to the third embodiment.

FIGS. 13A-13C are a cross-sectional view of a reflect array according to the third embodiment.

FIG. 14 is a cross-sectional view of a reflect array according to the third embodiment.

FIG. 15 is a diagram showing the results of evaluation by simulation of whether the reflection control region can obtain desired reflection phase characteristics.

FIG. 16 is a diagram showing the results of evaluation when a reflect array is produced.

FIGS. 17A-17C are a diagram illustrating element pattern shapes.

FIGS. 18A-18D are a diagram illustrating element pattern shapes.

### DETAILED DESCRIPTION

With reference to the drawings, some embodiments of the present invention will be described. It should be noted that the present invention is not limited to the following embodiments. In the following description of the drawings, identical components are denoted by the same reference signs.

Further, when there are a plurality of components having the same or similar functions, the same reference signs with different subscripts may be used. Furthermore, when it is not necessary to distinguish the plurality of components, subscripts may be omitted in the description.

The “surface” described herein may refer not only to a surface of a plate-like member, but also to an interface of layers included in the plate-like member and substantially parallel to the surface of the plate-like member. Further, the “upper surface” and “lower surface” refer to surfaces shown on the upper side and lower side of the plate-like member or the layers included in the plate-like member as viewed in the drawings. In addition, the “upper surface” and “lower surface” may also be called “first surface” and “second surface,” respectively.

The distance in the z axis direction may be referred to as “thickness.”

Further, a “cross-sectional view” may show a part or all of a cross-section of an object.

In addition, “obtaining desired reflection phase characteristics” means having characteristics that generate multiple target reflection phases. For example, if the difference between the upper and lower limits of the reflection phase can be set to a desired phase difference when a certain parameter is changed within a predetermined range, or if the multiple target reflection phases can be obtained when a certain parameter is changed within a predetermined range, it can be said that “desired reflection phase characteristics are obtained.”

### First Embodiment

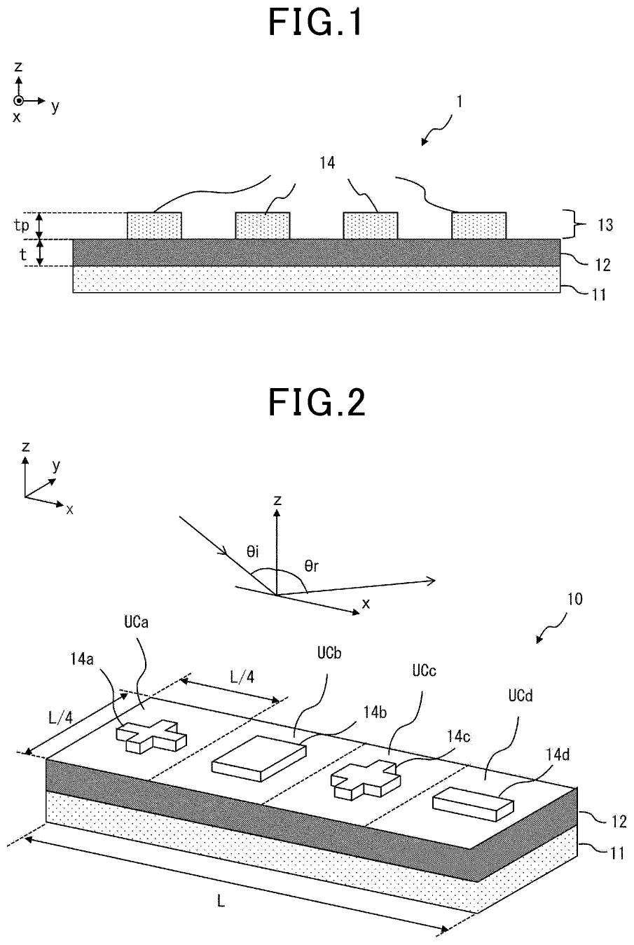

FIG. 1 is a cross-sectional view of a reflect array 1 according to a first embodiment. The reflect array 1 includes a ground layer 11, a dielectric layer 12 and an element pattern layer 13. The element pattern layer 13 is a layer having a plurality of element patterns 14. As will be described later, the element pattern layer 13 has a thickness tp of, for example, 10 nm or greater and 18 μm or less.

### (Ground Layer)

The ground layer 11 is provided to reflect electromagnetic waves reaching the reflect array 1. It is also provided to support and protect a dielectric layer 12, which will be described later. The ground layer 11 is made of a conductive material such as an inorganic oxide material, a metal material or a conductive organic material.

Examples of the inorganic oxide material and the metal material include indium tin oxide (ITO), indium zinc oxide (IZO), aluminum zinc oxide (AZO), gallium zinc oxide (GZO), antimony tin oxide, Ag, Al, Au, Pt, Pd, Cu, Co, Cr, In, Ag—Cu, Cu—Au and Ni. Nanoparticles or nanowires containing at least one of these materials may also be used. Examples of the conductive organic material include polythiophene derivatives, polyacetylene derivatives, polyaniline derivatives, polypyrrole derivatives, carbon nanotubes and graphene. In particular, Cu and Al are preferred from the viewpoint of material cost, electrical conductivity and film-forming properties. In order to reflect electromagnetic waves, the ground layer 11 preferably has a surface resistance of 100Ω/□ or less, and as long as this condition can be satisfied, inorganic oxide materials such as ITO or organic materials such as a mixture (PEDOT/PSS) of polyethylenedioxythiophene (PEDOT) and polystyrene sulfonic acid (PSS) may be used. By using an inorganic oxide material or an organic material, a transparent reflect array can be produced.

The above materials can be used in the form of a continuous film, a mesh shape, a punched shape and a periodic structure.

The term “mesh” refers to a state in which mesh-like through holes (openings) are formed in a flat surface of a conductor. When the conductor is formed in a mesh shape, the mesh holes may have a rectangular or diamond shape. When the mesh holes are formed in a rectangular shape, the mesh holes preferably have a square shape. The square mesh holes are excellent in design. Alternatively, a random shape may be formed by a self-organizing method. The random shape can prevent moiré. When a metal is processed into a mesh shape, methods such as punching a metal plate and etching a metal plate can be used.

When the ground layer has a mesh shape or when a transparent conductive material is used, the reflect array is transparent to visible light, making it possible to maintain the appearance after installation.

When the ground layer 11 has a mesh shape, the line width of the mesh is preferably 5 μm or greater and 30 μm or less, and more preferably 6 μm or greater and 15 μm or less. The line spacing of the mesh is preferably 50 μm or greater and 500 μm or less, and more preferably 100 μm or greater and 300 μm or less. Further, when the wavelength at the operation frequency (hereinafter, referred to as a “design frequency”) is λ0 (mm), the line spacing of the mesh is preferably 0.5×20 or less, more preferably 0.1×10 or less, and even more preferably 0.01×20 or less. The line spacing of the mesh of 0.5×20 or less ensures the performance of the ground layer 11. Further, the line spacing of the mesh may be 0.001×10 or greater.

When the ground layer 11 is formed of an inorganic oxide material or a metal material, the ground layer 11 preferably has a thickness of 18 μm or less, and more preferably in the range of 50 nm or greater and 2 μm or less. The film thickness of 50 nm or greater facilitates the formation of a uniform film without pinholes and enables the film to more fully function as the ground layer 11. Meanwhile, the film thickness of 2 μm or less can maintain sufficient flexibility, preventing the ground layer 11 from being cracked due to external factors, such as bending or stretching. Using the ground layer 11 with a thickness of 1 μm or less can improve the flexibility and facilitate bonding to a curved surface or the like. It also enables weight reduction.

When a metal material is used to form the ground layer 11, the formation method can be selected from dry coating such as sputtering or vapor deposition, wet coating such as gravure coating or die coating using inks made of metal materials, surface treatment such as plating, and the like. Alternatively, a rolled metal plate may be used as the ground layer 11. When an inorganic oxide material is used, dry coating can be selected as a method of forming the ground layer 11. When an organic material is used, wet coating can be selected as a method of forming the ground layer 11. Alternatively, the ground layer 11 may be formed by painting or spraying.

When the ground layer is in the form of a thin film formed by plating, vapor deposition, or the like, the flexibility of the reflect array can be improved, enabling use on curved surfaces and roll-to-roll production process.

Further, in order to improve the reflection efficiency of electromagnetic waves, the loss due to the ground layer may be reduced. Accordingly, it is preferred that the ground layer has low surface roughness.

When the ground layer is in the form of a periodic structure, it can exhibit a function of selectively reflecting or transmitting a specific frequency. For example, when a structure in which patch-shaped conductive patterns are periodically arranged is used as the ground layer, it can reflect only a specific frequency, thereby providing a function of transmitting frequencies other than the operating frequency. Further, when a structure in which portions where no conductive material is present are periodically provided as holes, it is possible to design a reflect array that transmits only a specific frequency while asymmetrically reflecting an operating frequency.

In the present disclosure, the surface resistance is measured in accordance with JIS-K-7194. The method of measuring surface resistance can be appropriately selected from a four terminal method, a two terminal method, a four probe method, a dielectric method, an eddy current method, and the like. The surface resistance of the ground layer 11 can be measured, for example, using a Loresta-GP MCP-T610 (trade name, manufactured by Mitsubishi Chemical Analytech Co., Ltd.).

### (Dielectric Layer)

In FIG. 1, the dielectric layer 12 has a thickness t. For the dielectric layer 12, synthetic resins such as ethylene vinyl acetate copolymer (EVA), vinyl chloride, urethane, acrylic, acrylic urethane, polyolefin, polyethylene, polypropylene, silicone, polyethylene terephthalate, polyester, polystyrene, polyimide, polycarbonate, polyamide, polysulfone, polyethersulfone, polytetrafluoroethylene, cycloolefin polymer and epoxy, and synthetic rubber materials such as polyisoprene rubber, polystyrene butadiene rubber, polybutadiene rubber, chloroprene rubber, acrylonitrile-butadiene rubber, butyl rubber, acrylic rubber, ethylene propylene rubber and silicone rubber can be used as resin components. Further, glass fibers, synthetic fibers, nonwoven fabrics or paper impregnated with these resin components may also be used. In particular, polyethylene terephthalate (PET) is preferably used since it is inexpensive and has excellent versatility. These resin materials and synthetic rubber materials can be used singly or in combination of two or more. The dielectric layer 12 may be a single layer or multiple layers. Further, the dielectric layer 12 may be formed of a foam obtained by foaming the above materials. As the foam, a foam having high flexibility is preferably used.

The relative dielectric constant of the dielectric layer 12 is preferably in the range of 1 or greater and 20 or less, more preferably in the range of 1 or greater and 10 or less, and even more preferably in the range of 2 or greater and 4 or less. With the relative dielectric constant within the above ranges, desired reflection phase characteristics tends to be easily obtained in the reflect array 1. Further, the dielectric loss tangent is preferably in the range of 0.00005 or greater and 0.01 or less, and more preferably in the range of 0.00005 or greater and 0.001 or less. Within the above ranges, a reflect array 1 having a small dielectric loss can be produced.

The dielectric layer 12 can be formed by, for example, wet coating such as die coating, comma coating or gravure coating, melt extrusion such as T-die or blown film extrusion, calender film formation, solution casting, thermal pressing, or the like. Alternatively, co-extrusion may be used in which a plurality of resins are extruded into a multilayer to form a film.

The thickness t of the dielectric layer 12 is appropriately selected depending on the design frequency. If the design frequency is 28 GHz, the thickness is preferably 40 μm or greater and 250 μm or less, and more preferably 50 μm or greater and 200 μm or less. An insufficient thickness makes it difficult to ensure the reflection phase, and the design of the reflect array 1 becomes difficult. On the other hand, an excessive thickness also tends to make it difficult to ensure the reflection phase, lose flexibility, and increase the total thickness of the reflect array 1, making it difficult to save space. Therefore, the thickness t of the dielectric layer 12 is preferably 250 μm or less. If the design frequency is 60 GHz, the thickness t of the dielectric layer 12 is preferably 10 μm or greater and 250 μm or less. If the design frequency is 100 GHz or greater, the reflect array 1 can be easily designed by setting the thickness t of the dielectric layer 12 to be about several μm or greater and 100 μm or less. Even when the thickness t of the dielectric layer 12 is 250 μm or less, a sufficient reflection phase may not be ensured depending on the relationship with the element length l of the element pattern 14, which will be described later. The reflect array 1 can be produced by satisfying both the relational formula between the element length l and the thickness t of the dielectric layer 12 and the relational formula between the wavelength λ0 and the thickness t of the dielectric layer 12 in formulas (6) and (7) described later. If the thickness t of the dielectric layer 12 is 1 μm or less, it tends to be difficult to stably form the dielectric layer 12 using the above-mentioned formation methods.

In addition to the above materials, the dielectric layer 12 may be formed of a resin component containing a metal compound. The density and dielectric constant of the dielectric layer 12 can be adjusted depending on the type and content of the metal compound in the dielectric layer 12. By containing a metal compound in the dielectric layer 12, flame-retardancy can be enhanced, and a fire spread prevention effect can be imparted. Examples of the metal compound include barium titanate, titanium oxide and zinc oxide. The metal compound is preferably in the form of powder (for example, nanoparticles).

The thickness t of the dielectric layer 12 may be measured by a micrometer method (JIS-C-2151). Further, the thickness may be measured using a spectroscopic interferometric film thickness meter, an electromagnetic film thickness meter, an eddy current film thickness meter, an infrared film thickness meter, an ultrasonic film thickness meter, an ellipsometer method, or the like. In addition, as a film thickness measurement method using a microscope, the thickness may be measured by a microphotograph method, a field micrometer method, an ocular micrometer method, a scanning electron microscopy method, or the like.

### (Element Pattern Layer)

The element pattern layer 13 is provided to asymmetrically reflect the incident electromagnetic waves in a direction different from the symmetric reflection. The thickness tp of the element pattern layer 13 may be, for example, 10 nm or greater and 18 μm or less. Considering flexibility and film-formability, a smaller thickness is preferred as long as it does not affect the function of asymmetrically reflecting electromagnetic waves.

The element pattern layer 13 preferably has a surface resistance of 100Ω/□ or less. The material used for the element pattern layer 13 may be, for example, a conductive material. Such a material may be the same material as that used for the ground layer 11. A conductive inorganic material or organic material may be deposited on the dielectric layer 12. From the viewpoints of flexibility, film-formability, stability, sheet resistance and low cost, it is preferred a film formed by vapor deposition, which will be described later, is used as the element pattern layer 13.

The above materials can be used in the form of a continuous film, a mesh shape and a punched shape.

The element pattern layer 13 may be formed by depositing a conductive material on the entire surface of the dielectric layer 12 to form a continuous film and then processing it to form an element pattern layer 13, or by forming an element pattern layer 13 directly on the dielectric layer 12.

When a metal is used as the method of forming a continuous film by depositing a conductive material on the entire surface of the dielectric layer 12, the formation method can be selected from dry coating such as sputtering or vapor deposition, plating or gravure coating using a metallic ink, wet coating such as die coating, and the like. Alternatively, a rolled metal plate may be bonded to the dielectric layer 12. Similarly, a continuous film can be formed by dry coating when an inorganic oxide material is used, or by wet coating when an organic material is used. Alternatively, painting or spraying may be used.

The formed continuous film can be subjected to removal processing such as dry etching, wet etching or cutting to remove unnecessary portions to thereby form an element pattern layer 13.

When the removal processing is performed by etching, the element pattern 14 constituting the reflect array 1 may be rounded at the end, pinholes may occur, the cross-sectional shape may have a forward tapered shape or a reverse tapered shape, or undercutting or over-etching may occur. Although such changes in shape are expected to occur by etching processing, it is acceptable as reflection phase characteristics if the direction of the main beam of the reflected electromagnetic waves is within the range of about ±5° of the designed reflection angle. It is also acceptable when the layer is formed by cutting, printing, dry coating, plating, painting or spraying.

When etching is used, the cross-sectional shape of the element pattern 14 shown in FIG. 1 preferably has a forward tapered shape in which the bottom widens in the −z axis direction. Due to the forward tapered shape, the surface area of the element pattern 14 increases, making it possible to enhance adhesion to the functional layer when the functional layer, which will be described later, is laminated.

Further, the element pattern layer 13 may be formed directly on the dielectric layer 12 by printing such as relief printing, planographic printing, intaglio printing, stencil printing, transfer printing, or the like, or masking portions of the dielectric layer 12 other than the element patterns 14 with a masking tape, a masking agent, or the like, followed by dry coating, plating, painting or spraying to form the element pattern layer 13.

The material for the element pattern layer 13 may be the same as or different from the material of the ground layer 11. For example, at least one of the ground layer 11 and the element pattern layer 13 may be made of Cu or Al. Since Cu has excellent electrical conductivity, conductor loss can be reduced. Since Al is low density, lightweight and inexpensive, a lightweight and inexpensive reflect array 1 can be formed. Further, the thickness of at least one of the layers may be 1 μm or less. The thickness of 1 μm or less can improve flexibility, facilitating installation of the reflect array 1 on a curved surface or the like, and also reduces weight.

When the element pattern has a mesh shape, the line width of the mesh is preferably 5 μm or greater and 30 μm or less, and more preferably 6 μm or greater and 15 μm or less. The line spacing of the mesh is preferably 50 μm or greater and 500 μm or less, and more preferably 100 μm or greater and 300 μm or less. Further, when the wavelength at the operation frequency is 20, the line spacing of the mesh is preferably 0.5×20 or less, more preferably 0.1×20 or less, and even more preferably 0.01×20 or less. The line spacing of the mesh of 0.5×20 or less can guarantee the performance. Further, the line spacing of the mesh may be 0.001×20 or greater.

When the element pattern has a mesh shape or when a transparent conductive material is used, the reflect array is transparent to visible light, making it possible to maintain the appearance after installation.

When the element pattern is in the form of a thin film, the flexibility of the reflect array can be improved, enabling use on curved surfaces and roll-to-roll production process.

Further, in order to improve the reflection efficiency of electromagnetic waves, the loss due to the element pattern may be reduced. Accordingly, it is preferred that the element pattern has low surface roughness.

### (Design Method)

FIG. 2 is a diagram schematically illustrating a part of the reflect array 1. FIG. 2 illustrates a reflection control region 10. The reflection control region 10 is a unit of a region capable of achieving asymmetric reflection. The reflect array 1 includes a plurality of reflection control regions 10 in the xy plane. The element pattern layer 13 includes a plurality of element patterns 14a to 14d.

The reflect array 1 is designed according to the following procedure. First, a length L, which is the length of the long side of the reflection control region 10, is determined by the following formula (1). Here, L is the length of the long side of the reflection control region, λ0 is the wavelength of the electromagnetic wave applied to the reflect array 1 (hereinafter, referred to as “wavelength at the operating (design) frequency”), θi is the incidence angle, and Or is the reflection angle. The incidence angle θi and the reflection angle θr are values measured on the zx plane.

Next, a length (L/n) obtained by dividing the length L of the long side of the reflection control region 10 by n is defined as a unit cell, which accommodates one element pattern. The area of the unit cell is a square having a unit cell size (L/n) on one side. In FIG. 2, the long side of the reflection control region 10 is divided into four and includes unit cells UCa to UCd. The unit cell UCa includes the element pattern 14a. The unit cell UCb includes the element pattern 14b. The unit cell UCc includes the element pattern 14c. The unit cell UCd includes the element pattern 14d.

Next, the reflection phase required in each reflection control region is determined by the following formula (2). Here, Zs(x) is a function of the surface impedance in the x direction in the xy plane of the reflection control region 10, and indicates the case where reflection without loss is achieved. Further, 120π is the impedance of the incident wave. The surface impedance is expressed by the following formula (3). Here, Φr(x) indicates the reflection phase which is the phase of the reflection coefficient, as shown in the following formula (4). The element shape is determined for each cell position to satisfy the reflection phase (angle of deviation R) shown in formula (5) from each formula. That is, by determining the incidence angle θi, the reflection angle θr, and the wavelength λ0 of the electromagnetic wave, it is possible to calculate the value of the reflection phase at the coordinate in the long side of the reflection control region 10.

$$\begin{matrix}[ Math . 2 ] & \\ L = \frac{{λ}_{0}}{\vert sin \text{?} - sin \text{?} \vert} & ( 1 )\end{matrix}$$

$$R = \frac{{Z}_{s} ( x ) - 120 π}{{Z}_{s} ( x ) + 120 π} \qquad ( 2 )$$

$${Z}_{s} ( x ) = \frac{120 π}{\sqrt{cos \text{?} cos \text{?}}} \frac{\sqrt{cos \text{?}} + \sqrt{cos \text{?}}}{\sqrt{cos \text{?}} - \sqrt{cos \text{?}}} \qquad ( 3 )$$

$$\text{?} ( x ) = ( sin \text{?} - sin \text{?} ) \frac{2 π x}{\text{?}} \qquad ( 4 )$$

$$ϕ = arg R \qquad ( 5 )$$

$$( \begin{matrix}\text{?} : Incidence angle \\ \text{?} : Reflection angle \\ {λ}_{0} : Wavelength of electromagnetic wave \\ x : Coordinate \\ {Z}_{S} : Surface impedance \\ R : Reflection coefficient \\ ϕ : Reflection phase\end{matrix} )$$

$$\text{?} \text{indicates text missing or illegible when filed}$$

### (Design Method for Element Pattern)

After the reflection phase is determined by the above method, the shape of the element pattern 14 is changed to satisfy the reflection phase in each unit cell, and a simulation is performed to optimize the shape of the element pattern 14. When an electromagnetic wave is incident on the element pattern, the relationship between the shape of the element pattern 14 and the reflection phase can be determined by a simulation using, for example, an electromagnetic analysis tool (High Frequency Structure Simulator: HFSS), or the like. Examples of the shape of the element pattern include a cross-patch shape (cruciform) (element patterns 14a and 14c) and a rectangular shape (element patterns 14b and 14d).

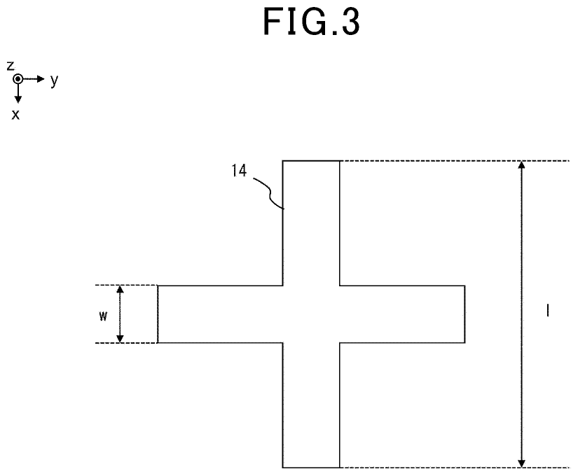

The case where the element pattern 14 is a cross-patch will be described. FIG. 3 is a diagram illustrating a cross-patch element pattern 14. The cross-patch refers to a shape in which two rectangular patches are perpendicular to each other in the xy plane. The element pattern 14 is one of the plurality of element patterns included in the element pattern layer 13. The length of the cross-patch element pattern 14 is defined as an element length l, and the width of the cross-patch element pattern 14 is defined as an element width w. The reflection phase of the unit cell UC is controlled by varying either or both of the element length l and the element width w. When the element length l is fixed, it is desired to set the value of the element length l as large as possible in the unit cell UC. By setting a large value, desired reflection phase characteristics can be easily obtained. Further, when the element width w is fixed, it is desired to set the value of the element width w as large as possible in the unit cell UC. By setting a large value for the element width w, the inclination of the reflection phase becomes gentle, which increases the processing accuracy during processing. The element length l is not limited to the cross-patch element pattern, but may also be set for element patterns having other shapes. In addition, the element length l can be set to a common length in the reflection control region 10, or can be set to a different length for each element pattern included in the reflection control region 10.

### (Design Method for Dielectric Layer)

In addition to the above design, as a result of examining the relationship between the thickness t (mm) and the element length 1 (mm) of the dielectric layer 12, it was found that the desired reflection phase characteristics can be obtained when the following relational formula (6) is satisfied. By satisfying formula (6), a thin film reflect array 1 can be obtained. It was found that a desired reflection phase can be obtained when 1≥4.4×t, while a good reflection phase cannot be obtained when 1<4.4×t. It was also found that it is difficult to produce the reflect array 1 having flexibility when the thickness t of the dielectric layer 12 is greater than 0.25 mm, and it is difficult to produce the dielectric layer 12 when the thickness t of the dielectric layer 12 is smaller than 0.001 mm.

$$\begin{matrix}[ Math . 3 ] & \\ 1 \geq 4.4 \times t and 0.001 < t < 0.25 & ( 6 )\end{matrix}$$

Further, as a result of examining the relationship between the operating frequency (wavelength λ0 (mm) at the operating frequency) and the thickness t (mm) of the dielectric layer 12, it was found that the desired reflection phase characteristics can be obtained when the following relational formula (7) is satisfied. It was found that a desired reflection phase can be obtained when formula (7) is satisfied, while a good reflection phase cannot be obtained when formula (7) is not satisfied.

$$\begin{matrix}[ Math . 4 ] & \\ 0.001 < t < 0.065 \times λ 0 & ( 7 )\end{matrix}$$

### (Example of Reflection Phase)

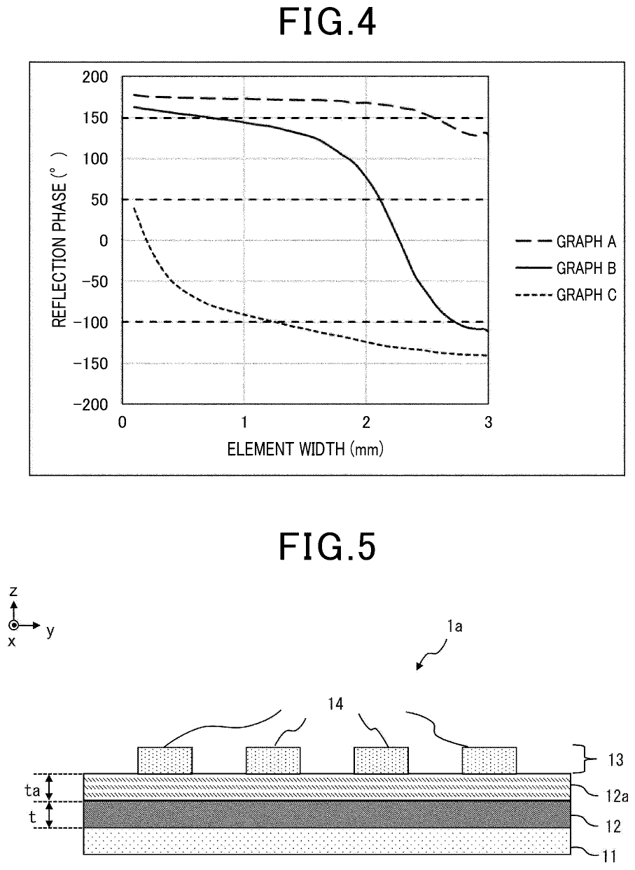

With reference to FIG. 4, the reflection phase characteristics will be described. FIG. 4 is a diagram illustrating an example of the results of a simulation performed on a unit cell.

When simulating the reflection phase with an electromagnetic analysis tool HESS while fixing the element length l and changing the element width w, the phase changes as shown in graphs A to C can be typically detected. In graphs A to C, the configurations of the ground layer 11, the dielectric layer 12 and the element pattern layer 13 are common, but the thickness t of the dielectric layer 12 is 40 μm in graph A, 200 μm in graph B, and 800 μm in graph C. The element length l is 3.00 mm. For example, when three points of 150°, 50° and −100° indicated by the dotted lines are to be included in the range of the reflection phase, graph B can include all three points. Thus, in the reflection phase characteristics of graph B, when the element width w is varied within a predetermined range, the difference between the upper and lower limits of the reflection phase can be set to a desired phase difference, making it possible to obtain multiple desired target reflection phases. That is, it is possible to “obtain desired reflection phase characteristics” in graph B. The “desired phase difference” is preferably a value close to 360°, but is not limited thereto. Further, the “multiple desired target reflection phases” are preferably values of a plurality of reflection phases that are substantially evenly dispersed within 360°. In the case of FIG. 4, for example, even when the element width w has an upper limit on the size of the unit cell and is limited to 3 mm or less, it is possible to form a unit cell including an element pattern having a reflection phase of 150°, a unit cell including an element pattern having a reflection phase of 50°, and a unit cell including an element pattern having a reflection phase of −100°. By providing the reflection control region 10 including at least these unit cells, it is possible to form the reflect array 1 that functions at a desired operating frequency. The predetermined range of the element width w is determined based on the size of the reflect array 1. Further, the multiple target reflection phases are determined based on the reflection phase characteristics required for the reflect array 1. In FIG. 4, the element width w is varied within a predetermined range, but the element length l may be varied within a predetermined range. In this case also, it is desired to have a configuration that can “obtain desired reflection phase characteristics” when the element length l is varied within a predetermined range.

On the other hand, as seen from the changes in reflection phase shown in graphs A and C, the phases of 50° and −100° cannot be obtained in graph A. Further, the reflection phases of 150° and 50° cannot be obtained in graph C. Thus, since the multiple target reflection phases cannot be obtained in a predetermined range of the element width w, it is not possible to “obtain desired reflection phase characteristics” in graphs A and C.

Although the case of the cross-patch element pattern 14 has been described, the above design method can also be applied to element patterns having other shapes than the cross-patch. Examples of the other shapes include any shape such as a circular or square shape, but in consideration of compatibility with vertically or horizontally polarized waves, a structure that maintains symmetry when rotated 90° is desired.

In the above design method, the element length l and the element width w are determined to design the element pattern, but the parameters for adjusting the arrangement of the element pattern to obtain “desired reflection phase characteristics” are not limited to the element length l and the element width w, and may be appropriately specified according to the element pattern.

### (Production Method)

The reflect array 1 can be produced as follows.

First, the dielectric layer 12 is formed. The dielectric layer 12 is formed in a film shape.

Next, the ground layer 11 is formed on one surface of the dielectric layer 12. Also, a continuous film for forming the element pattern layer 13 is formed on the other surface of the dielectric layer 12. The method of forming the ground layer 11 and the continuous film is appropriately selected from sputtering, vapor deposition, plating, and the like depending on the film thickness. Alternatively, a rolled metal plate may be used to form the element pattern layer 13.

Next, the continuous film is etched into a target shape of the element pattern to form the element pattern layer 13. Thus, the reflect array 1 in which the ground layer 11, the dielectric layer 12 and the element pattern layer 13 are laminated in this order can be obtained.

As described above, the production method includes forming the ground layer 11 and the element pattern layer 13 on the dielectric layer 12. In addition to the above method, the ground layer 11 may be formed by printing a metal paste, a conductive ink, or the like. In addition to the above method, the element pattern layer 13 may be formed by applying conductivity to the entire dielectric layer 12 and then removing a portion to form a pattern, or by forming the element pattern layer 13 directly on the dielectric layer 12.

### (Evaluation Method)

A simulation is performed to evaluate whether the desired reflection phase can be obtained, and if it can be obtained, the reflect array is designed and produced, and the reflection characteristics are evaluated. The reflection characteristics are evaluated by a bistatic method in which a transmitter is fixed (incident perpendicular to the sample) and the electromagnetic waves reflected at the design angle via the reflect array are received using a receiver. Then, the sample subjected to the evaluation of reflection characteristics is wound around a core with an inner diameter of 6 inches and thickness of 8 mm, held for 1 minute, and examined for abnormalities in appearance (such as folds or bend marks) and bending evaluation of whether the shape returns to the original shape. Then, the reflection characteristics are evaluated again as the characteristics after bending evaluation, and it is examined whether the reflection characteristics are affected before and after the bending evaluation. Although the evaluation is performed using the Young's modulus and winding around a core as the bending evaluation indices, the evaluation may also be performed using indices such as a bending test at an arbitrary radius of curvature and bending rigidity.

### Modifications of First Embodiment

FIG. 5 is a cross-sectional view of a reflect array 1a according to a modified example of the first embodiment. The modified example of the first embodiment includes a plurality of dielectric layers 12. In the following description, components that are the same or equivalent to those in the first embodiment described above are denoted by the same reference signs, and the description thereof will be simplified or omitted.

In the reflect array 1a, a dielectric layer 12a is formed on the dielectric layer 12. The element pattern layer 13 is formed on the dielectric layer 12a. The dielectric layer 12a can be made of a material different from the material used for the dielectric layer 12. As the production method, the same method as the method that can be used for the dielectric layer 12 can be selected. A thickness ta of the dielectric layer 12a can also be set appropriately.

The reflect array 1a includes two layers, the dielectric layer 12 and the dielectric layer 12a, but the configuration is not limited thereto. The dielectric layer may be formed of three or more layers.

By changing the number of layers or the thickness of the dielectric layer, the reflection phase characteristics and the reflection characteristics can be changed.

### Second Embodiment

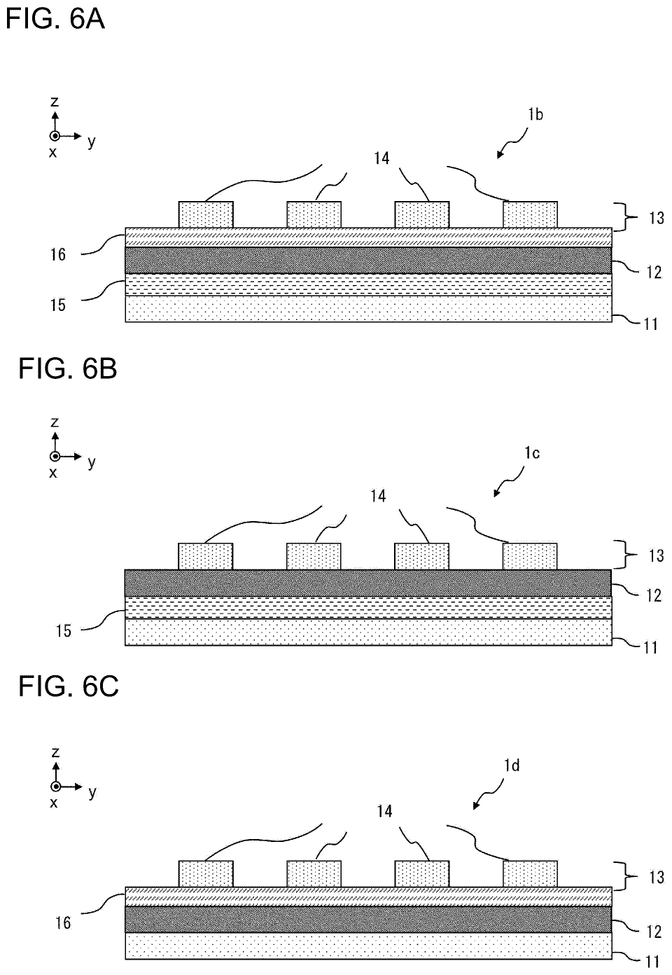

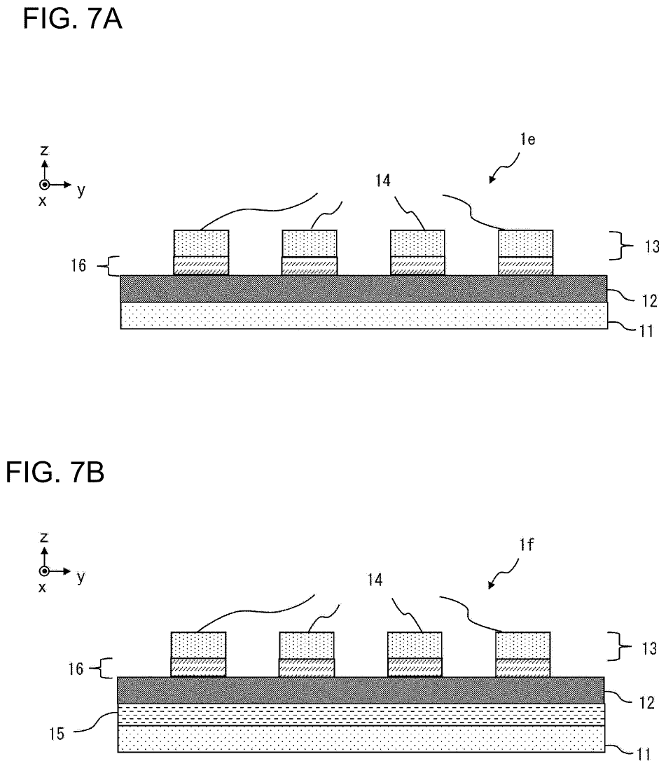

The second embodiment differs from the first embodiment in that an adhesion-enhancement layer is provided. FIGS. 6A-6C, 7A, and 7B are cross-sectional views of a reflect array according to the second embodiment. In the following description, components that are the same or equivalent to those in the first embodiment described above are denoted by the same reference signs, and the description thereof will be simplified or omitted.

When interlayer adhesion cannot be obtained between the dielectric layer 12 and the ground layer 11 or between the dielectric layer 12 and the element pattern layer 13, an adhesion-enhancement layer can be provided to improve adhesion. Examples of the adhesion-enhancement layer include an adhesion enhancement layer that facilitates adhesion between layers and an adhesive layer that has adhesiveness between layers.

There are many variations in the method of forming the adhesion-enhancement layer. For example, as shown in a reflect array 1b of FIG. 6A, an adhesion-enhancement layer 15 and an adhesion-enhancement layer 16 can be formed between the dielectric layer 12 and the ground layer 11 and between the dielectric layer 12 and the element pattern layer 13, respectively. In addition to the case of providing both adhesion-enhancement layers, an adhesion-enhancement layer may be provided only between the dielectric layer 12 and the ground layer 11 as shown in a reflect array 1c of FIG. 6B, or only between the dielectric layer 12 and the element pattern layer 13 as shown in a reflect array 1d of FIG. 6C. Further, as shown in a reflect array 1e of FIG. 7A and in a reflect array 1f of FIG. 7B, an adhesion-enhancement layer may be provided according to the arrangement of the element pattern layer 13.

When the adhesion-enhancement layers are provided between the dielectric layer 12 and the ground layer 11 and between the dielectric layer 12 and the element pattern layer 13, the adhesion-enhancement layers may be made of the same material or different materials. Further, the adhesion-enhancement layer may be composed of two or more layers, or may be composed of a combination of a plurality of materials.

The adhesion-enhancement layer 16 shown in FIG. 6C covers one surface of the dielectric layer 12. Since this prevents the dielectric layer 12 from being exposed to the external environment, the effect of preventing deterioration of the dielectric layer 12 is expected. Thus, the layer can be protected by the method of forming the adhesion-enhancement layer.

### (Examples of Configuration)

1, Adhesion-enhancement layers are provided between the dielectric layer 12 and the ground layer 11 and between the dielectric layer 12 and the element pattern layer 13, respectively. (FIGS. 6A and 7B)

2, An adhesion-enhancement layer is provided only between the dielectric layer 12 and the ground layer 11. (FIG. 6B)

3, An adhesion-enhancement layer is provided only between the dielectric layer 12 and the element pattern layer 13. (FIGS. 6C and 7A)

### Third Embodiment

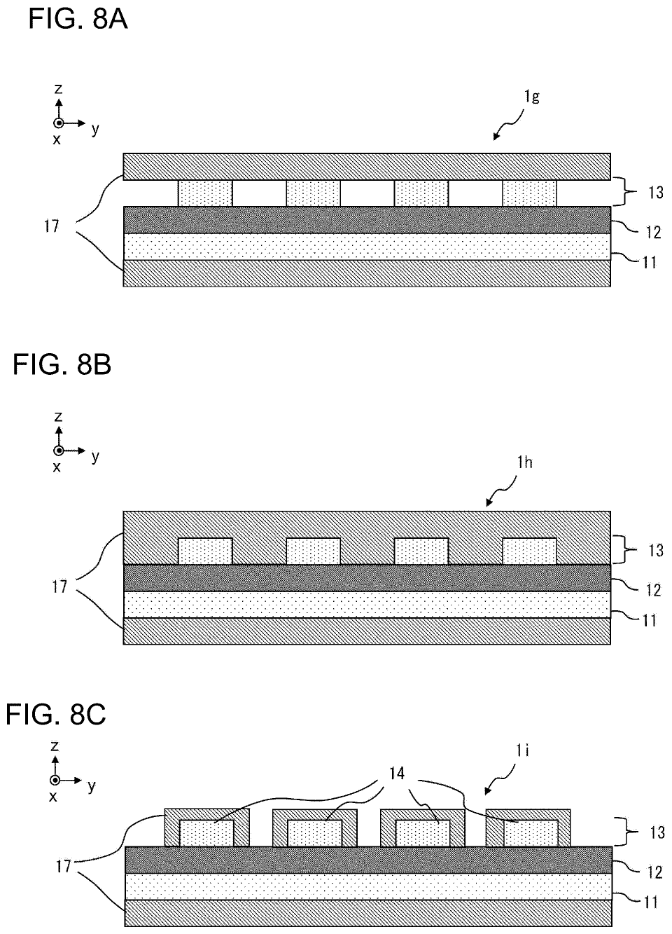

The third embodiment differs from the first embodiment in that a functional layer is provided. FIGS. 8A-8C, 9A, 9B, 10A-10C, 11A-11C, 12A-12C, 13A-13C, to 14 are cross-sectional views of a reflect array according to the third embodiment. In the following description, components that are the same or equivalent to those in the first embodiment described above are denoted by the same reference signs, and the description thereof will be simplified or omitted.

### (Addition of Functions)

The reflect array can be provided with functions as necessary. Examples of the functions added include deterioration prevention, design, protection/scratch-resistance, waterproofing, gas/water vapor barrier properties, flame-retardancy, nonflammability, self-extinguishing, weatherability, antifouling, antibacterial/antiviral properties, chemical resistance, deodorizing properties, and pressure-sensitive adhesive/adhesion properties. One of these functions may be added, or a combination of some functions may be added.

Functions may be imparted by adding a functional layer 17, which is a layer having a function, to the reflect array, or mixing materials that produce functions when forming the dielectric layer 12. Alternatively, the reflect array may be coated with materials having functions.

The functional layer 17 can be formed on at least one of the element pattern layer 13, the ground layer 11 and the dielectric layer 12 depending on the purpose. Further, the functional layer 17 may be formed on the entire surface of the element pattern layer 13, the ground layer 11 and the dielectric layer 12, or may be formed only on a portion of any of the layers.

### (Example of Functions)

### Weatherability

The reflect array may be deteriorated by oxidation or absorption of water vapor due to exposure to the atmosphere, alteration due to light (UV light) such as sunlight, or the like. In order to prevent deterioration due to oxygen or water vapor, it is conceivable to provide a layer having excellent gas barrier properties on the surface of the reflect array. Further, in order to prevent deterioration due to oxygen in particular, the oxygen permeability of the functional layer is preferably 500 cc/m²·atm·day or less. As long as this condition can be satisfied, a film may be laminated, or an overcoat layer may be provided by dry coating or wet coating. These layers may be a single layer, or a plurality of layers may be combined or laminated.

Further, in order to prevent deterioration of the dielectric layer 12, an antioxidant, an anti-deterioration agent or an antioxidant material may be added when forming the dielectric layer 12.

Similarly, in order to prevent deterioration due to water vapor, it is preferred to provide a layer having the water vapor permeability of 300 g/m² day or less.

In order to block light from sunlight or the like, it is conceivable to provide a film having UV-cutting properties or a layer having light-shielding properties. Further, a UV scattering agent, a UV absorber or a light stabilizer may be added.

### Design

When the reflect array is installed on the exterior or interior of a building, it may be designed to harmonize with the space. Specifically, a sheet-shaped material having a design may be bonded to the reflect array using an adhesive, or a sheet-shaped material may be welded and bonded to the reflect array by applying heat and pressure to thereby provide the design.

### Protection and Scratch-Resistance

Protection and scratch-resistance refer to the function of preventing the reflect array from being scratched or preventing deterioration of the reflect array itself. Such functions can be added by increasing the surface hardness of the reflect array by a coating process, or by laminating a hard coat film. Protection and scratch-resistance are evaluated by a pencil hardness test according to JIS K 5600 May 4, and a hardness of H or higher is preferred. Further, when rubbing with steel wool (#0000) at a load of 1,000 gf/cm², it is preferred that no scratches occur until the number of reciprocating strokes exceeds 1,000.

### Flame-Retardancy, Nonflammability and Self-Extinguishing

Flame-retardancy and nonflammability can be imparted to the reflect array by laminating a nonflammable material, a semi-nonflammable material or a flame-retardant material to which the fire prevention certification stipulated in the Building Standards Act is applied. For example, flame-retardant fibers, flame-retardant plastics, nonflammable paints and flame-retardant paints can be used. Examples of the flame-retardant fibers include halogen compounds, phosphorus compounds, vinylon fibers, polyetherimide fibers, aramid fibers and polyester fibers. Examples of flame-retardant plastics include plastic materials to which halogen-based, phosphorus-based, or inorganic flame-retardants such as aluminum hydroxide or magnesium hydroxide are added.

Further, examples of self-extinguishing materials include nylon, polycarbonate and vinyl chloride.

The formation method includes laminating layers using these materials, and mixing these materials when forming the dielectric layer 12. Further, flame-retardant plastics or fibers can be used as they are as the materials for the dielectric layer 12.

### Antifouling, Antibacterial and Antiviral Properties

As a method of imparting antifouling properties to the reflect array, a substrate having hydrophilicity or water-repellency can be laminated or coated. Examples of hydrophilic materials that can be used include photocatalytic materials and silica-based materials. Examples of water-repellent materials that can be used include fluororesin materials and silicone-based materials. Antibacterial and antiviral materials include photocatalytic materials, chlorine-based materials, organic materials containing cationic polymers, and materials containing metal-supported systems such as silver and zinc. The formation method includes laminating these materials as films, using these materials in a coating process, and mixing these materials when forming the dielectric layer 12.

### (Configuration)

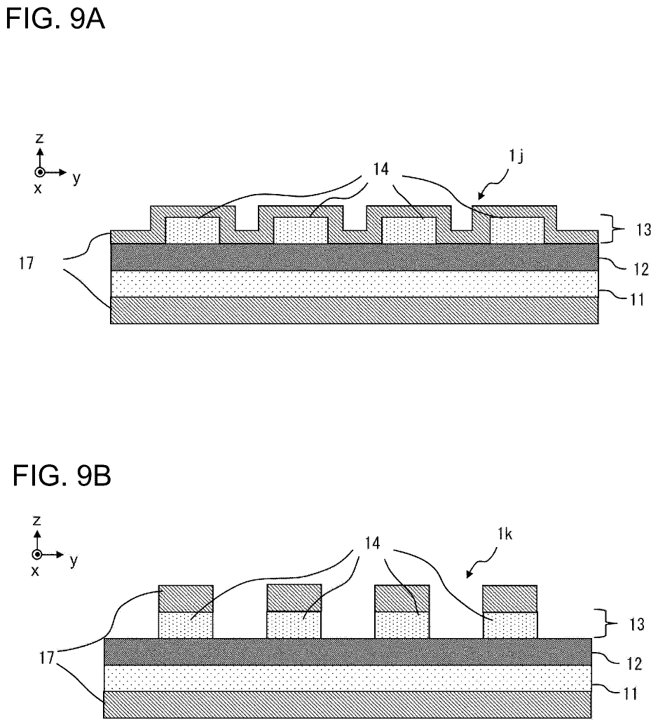

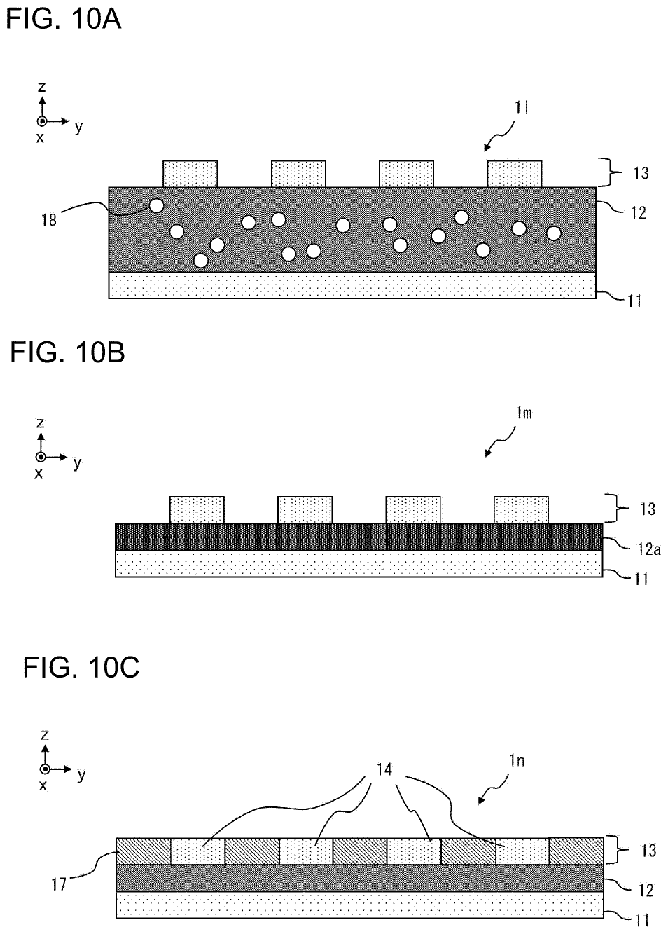

There are many variations in the method of forming the functional layer. For example, as shown in FIGS. 8A-8C, 9A, and 9B, a layer having a function can be laminated on the ground layer 11 and the element pattern layer 13, or as shown in FIGS. 10A-10C, a material having an additional function can be mixed in the dielectric layer 12.

In FIG. 8A, a functional layer 17 is formed on the surface of the ground layer 11 facing the −z axis direction, and another functional layer 17 is formed on the element pattern layer 13. In FIG. 8B, a functional layer 17 is formed on the dielectric layer 12. In FIG. 8C, a functional layer 17 is formed to cover the element patterns 14, and is not formed at positions where the element pattern 14 is not present.

Further, in FIG. 9A, a functional layer 17 is formed to cover the element patterns 14 and the dielectric layer 12. In FIG. 9B, a functional layer 17 is formed only on the upper surface of the element patterns 14.

Further, in a reflect array 11 of FIG. 10A, a functional material 18, which is a material having a function, is mixed in the dielectric layer 12. In a reflect array 1m of FIG. 10B, a dielectric layer 12a containing a material for exhibiting a function is used. Further, in FIG. 10C, a functional layer 17 is formed on the dielectric layer 12 at positions where the element pattern 14 is not provided.

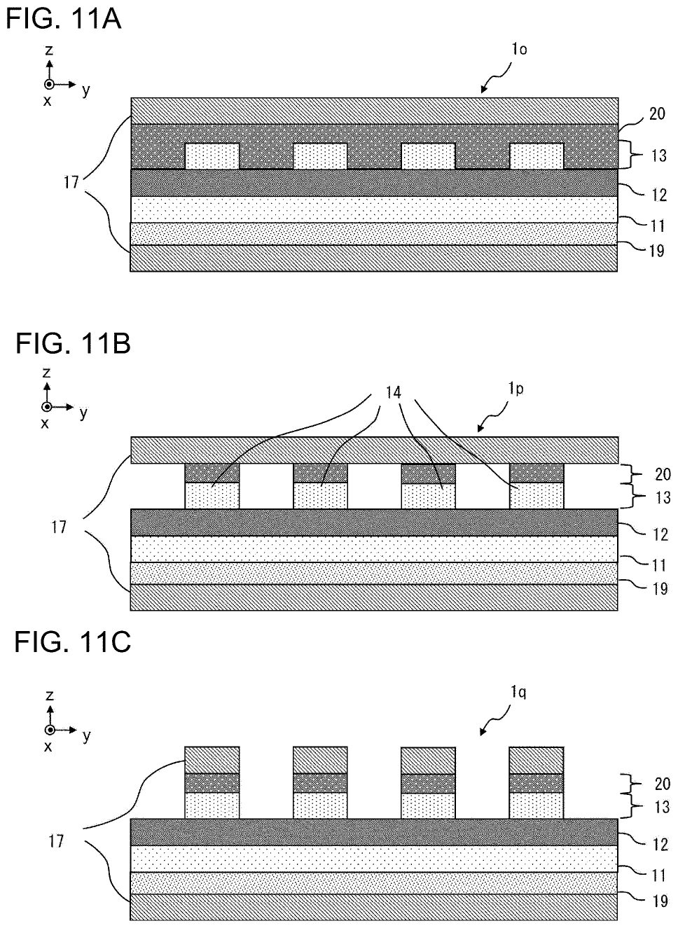

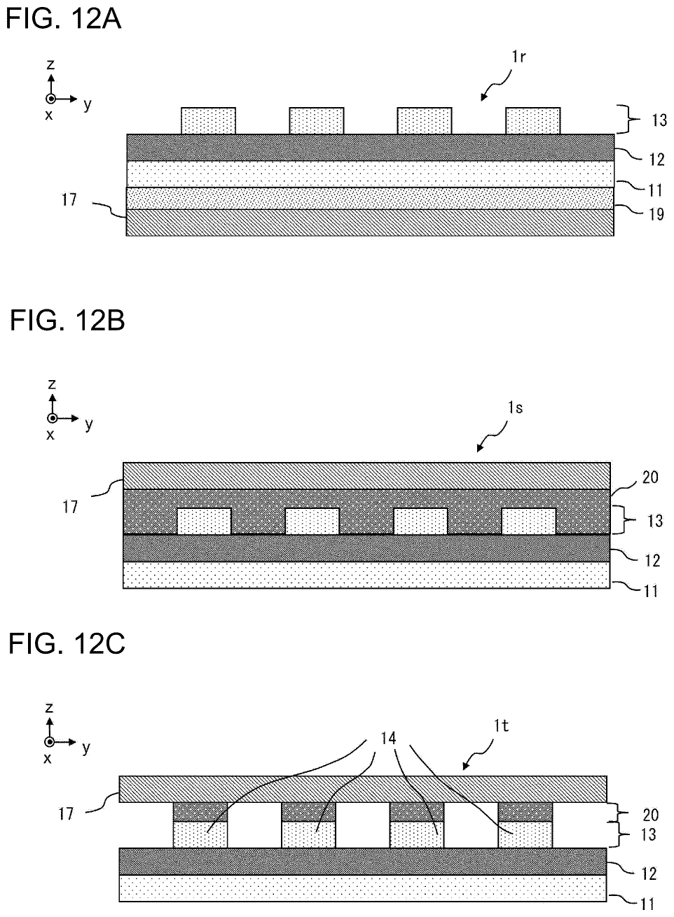

If a functional layer does not have pressure-sensitive adhesiveness or adhesiveness, an adhesion-enhancement layer can also be used. FIGS. 11A-11C, 12A-12C, to 13A-13C illustrate the cases where an adhesion-enhancement layer is used.

In FIG. 11A, an adhesion-enhancement layer 19 is formed between the ground layer 11 and the functional layer 17, and an adhesion-enhancement layer 20 is formed between the dielectric layer 12 and the functional layer 17. In FIG. 11B, an adhesion-enhancement layer 20 formed between the dielectric layer 12 and the functional layer 17 is formed only on the upper surface of the element patterns 14. In FIG. 11C, a functional layer 17 is formed in accordance with the arrangement of the element patterns 14.

Further, in FIG. 12A, a functional layer 17 is not formed on the surface of the layer facing the +z axis direction, and an adhesion-enhancement layer 19 is formed between the functional layer 17 and the ground layer 11. In FIG. 12B, a functional layer 17 is not formed on the surface of the layer facing the −z axis direction, and an adhesion-enhancement layer 20 is formed between the functional layer 17 and the dielectric layer 12. In FIG. 12C, an adhesion-enhancement layer 20 is formed only on the upper surface of the element patterns 14.

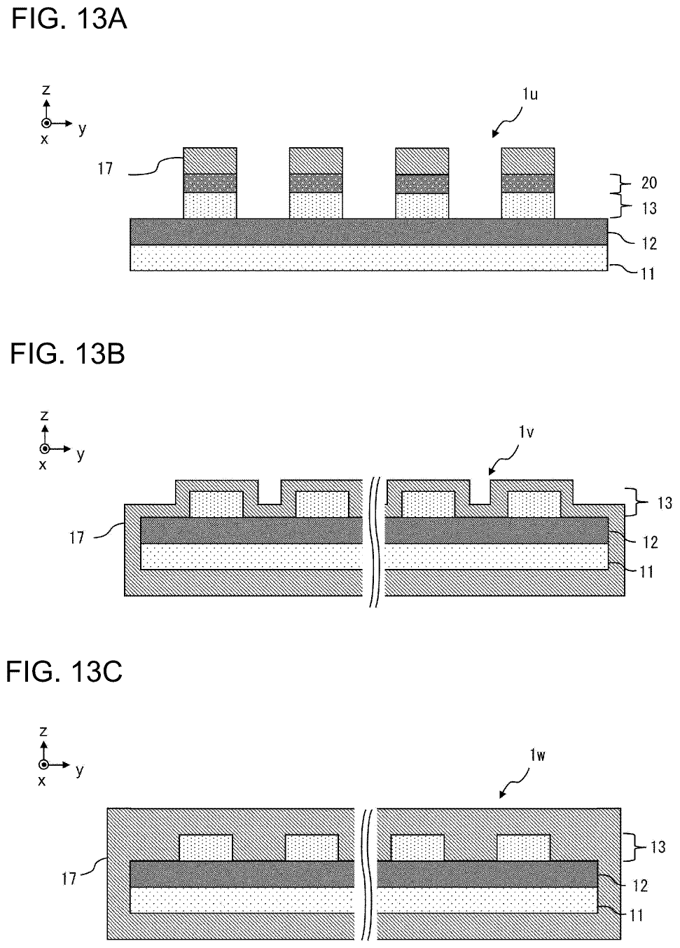

Further, in FIGS. 13A-13C, a functional layer 17 is formed in accordance with the arrangement of the element patterns 14. In FIGS. 13B and 13C, a functional layer 17 is formed to cover the ends of the reflect arrays 1v and 1w.

As described above, a functional layer 17 may be formed on both the ground layer 11-side and the element pattern layer 13-side, only on the ground layer 11-side, only on the element pattern layer 13-side, or on the dielectric layer 12. When functional layers are formed on both the ground layer 11 and the element pattern layer 13, respectively, the layers formed may have the same function or different functions. When a functional layer is laminated, it may be a single layer or multiple layers. Further, even when a functional layer is formed of a single layer, a combination of materials having a plurality of functions may be used in the single layer.

### (Examples of Configuration)

1, Functional layers are provided on both the ground layer 11 and the element pattern layer 13, respectively. (FIGS. 8A-8C, 9A, and 9B)
2, A functional layer is provided only on the ground layer 11-side. (FIG. 12A)
3, A functional layer is provided only on the element pattern layer 13-side. (FIGS. 12B, 12C and 13)
4, A functional layer is provided only on the dielectric layer 12. (FIG. 10C)
5, A functional layer is also provided on the ends of the reflect array. (FIGS. 13B and 13C)
6, Functional layers are provided on both the ground layer 11 and the element pattern layer 13, respectively, and an adhesion-enhancement layer is provided. (FIGS. 11A-11C)
7, A functional layer is provided only on the ground layer 11, and an adhesion-enhancement layer is provided. (FIG. 12A)
8, A functional layer is provided only on the element pattern layer 13, and an adhesion-enhancement layer is provided. (FIGS. 12B, 12C and 13A)
9, The functional material 18 is mixed in the dielectric layer 12. (FIG. 10A)

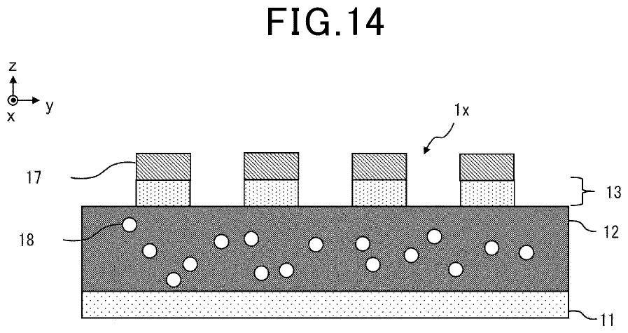

The above configurations 1 to 8 can be combined. For example, configurations 1 and 9 can be combined to form a reflect array 1x shown in of FIG. 14.

### (Evaluation Results)

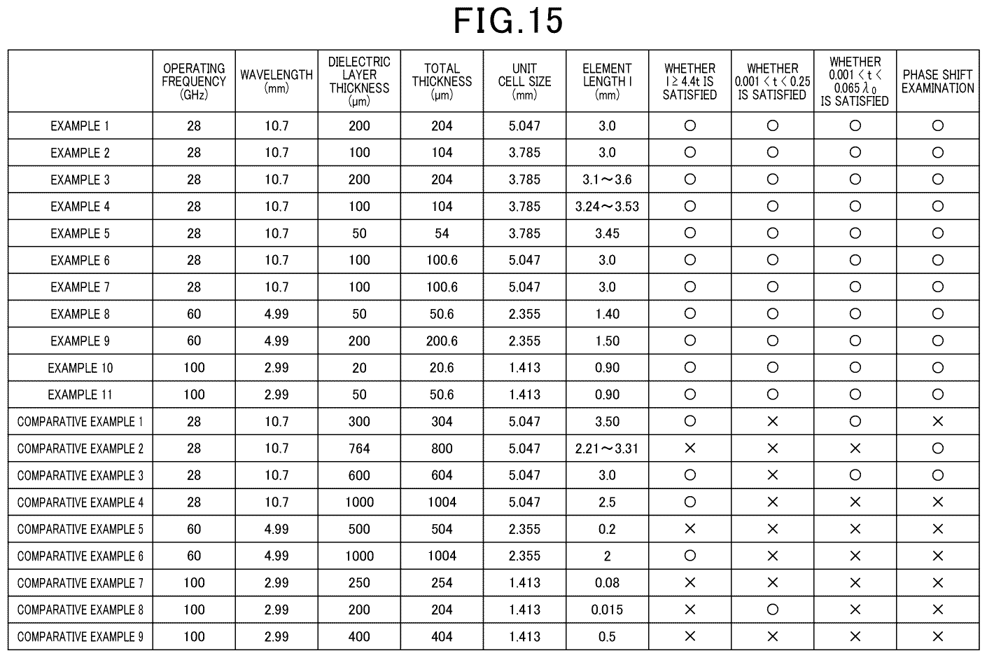

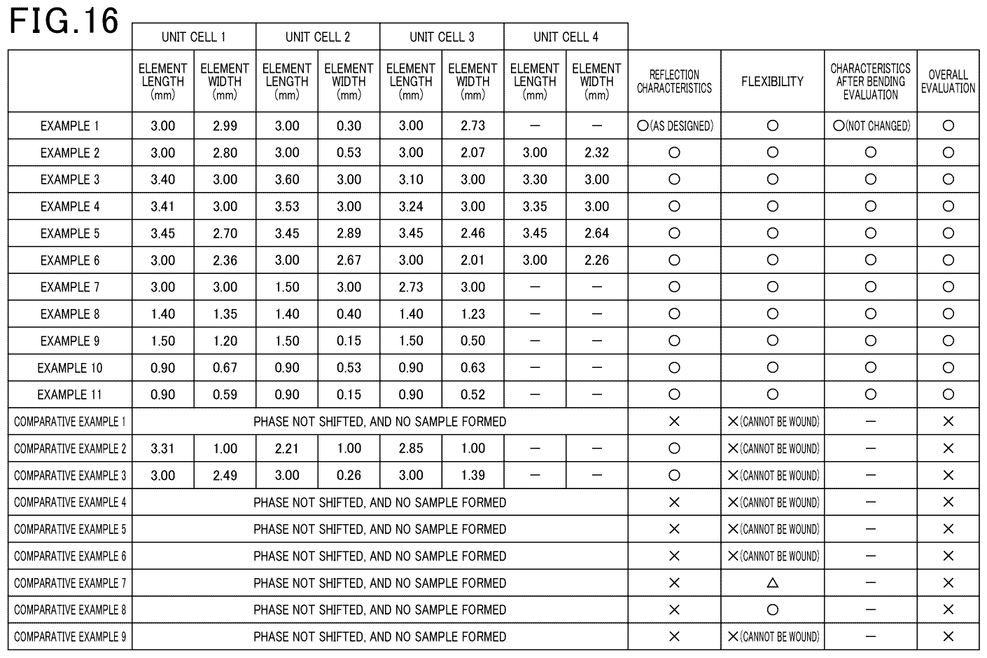

Reflect arrays were designed and produced at operating frequencies ranging from 28 GHz to 100 GHz, an incidence angle of 0° and a reflection angle of 45°. Based on the structure formed of the ground layer 11, the dielectric layer 12 and the element pattern layer 13 according to the first embodiment, examples and comparative examples were produced and evaluated. FIG. 15 is a diagram showing the results of evaluation by simulation of whether the reflection control region can obtain desired reflection phase characteristics. FIG. 16 is a diagram showing the results of evaluation when a reflect array is produced.

Evaluation categories include “phase shift examination” “reflection characteristics” “characteristics after bending evaluation” and “flexibility.” Table 1 shows the evaluation criteria for each category. The “phase shift examination” indicates whether the design described above can “obtain desired reflection phase characteristics.” The “reflection characteristics” indicate whether a peak (e.g., a maximum value) of the intensity of the electromagnetic wave can be obtained at the designed operating frequency, incidence angle and reflection angle. The “flexibility” indicates whether the sample that has been wound around a core with the inner diameter of 6 inches and the thickness of 8 mm and held for 1 minute has abnormalities in appearance such as wrinkles and folds by visual inspection. The “characteristics after bending evaluation” indicates whether the rate of change of the peak intensity of the reflected wave for a sample after the flexibility evaluation is within ±3% when measured under the same conditions as those used to evaluate the reflection characteristics. In FIGS. 15 and 16, “∘” indicates that the evaluation criteria below is satisfied and “x” indicates the criteria is not satisfied.

TABLE 1

| Category | Judgement condition |
|---|---|
| Phase shift examination | The design described above can “obtain desired reflection phase |
| | characteristics.” |
| Reflection characteristics | The peak intensity of the electromagnetic wave can be obtained |
| | at the designed operating frequency, incidence angle and |
| | reflection angle. |
| Flexibility | The sample is wound around a core with the inner diameter of 6 |
| | inches and the thickness of 8 mm and held for 1 minute. |
| | No abnormalities in appearance such as wrinkles and folds by |
| | visual inspection. |
| Characteristics after bending | When a sample after the flexibility evaluation is subjected to |
| evaluation | measurement under the same conditions as those used to |
| | evaluate reflection characteristics, the rate of change of the peak |
| | intensity of the reflected wave is within ±3%. |

### Example 1

A 200 μm-thick PET was used as the dielectric layer 12. 2 μm-thick Cu layers were formed on both sides of the dielectric layer 12 by plating as layers for forming the ground layer 11 and the element pattern layer 13, respectively. One of the Cu layers was etched to form the element pattern layer 13. The PET used had a dielectric constant of 3.03 and a dielectric loss tangent of 0.00476.

As shown in FIG. 15, in the simulation, the operating frequency was 28 GHZ, λ0 was 10.7 mm, the thickness t of the dielectric layer 12 was 200 μm, the total thickness (i.e., the thickness of the reflection control region; when a reflect array was formed, the thickness was the same as that of the reflect array) was 204 μm, the unit cell size was 5.047 mm, and the element length l was 3.0 mm. The conditions of formulas (6) and (7) were satisfied, and as indicated by “∘” in the “phase shift examination,” desired reflection phase characteristics could be obtained.

Further, as shown in FIG. 16, a reflect array including three unit cells was formed and evaluated. As indicated “∘” in both the “reflection characteristics” and the “flexibility,” the evaluation results satisfied the required level. Further, as indicated by “∘” in the “characteristics after bending evaluation,” the reflection characteristics were not affected even after the flexibility was evaluated. All the evaluation results were good, and are indicated “∘.” As indicated “∘” in the overall evaluation, the requirements of the reflect array were satisfied.

### Example 2

A 100 μm-thick PET was used as the dielectric layer 12. 2 μm-thick Cu layers were formed on both sides of the dielectric layer 12 by plating as layers for forming the ground layer 11 and the element pattern layer 13, respectively. One of the Cu layers was etched to form the element pattern layer 13. The PET used had a dielectric constant of 3.03 and a dielectric loss tangent of 0.00476.

As shown in FIG. 15, in the simulation, the operating frequency was 28 GHZ, λ0 was 10.7 mm, the thickness t of the dielectric layer 12 was 100 μm, the total thickness was 104 μm, the unit cell size was 3.785 mm, and the element length l was 3.0 mm. The conditions of formulas (6) and (7) were satisfied, and as indicated by “∘” in the “phase shift examination,” desired reflection phase characteristics could be obtained.

Further, as shown in FIG. 16, a reflect array including four unit cells was formed and evaluated. As indicated “∘” in both the “reflection characteristics” and the “flexibility,” the evaluation results satisfied the required level. Further, as indicated by “∘” in the “characteristics after bending evaluation,” the reflection characteristics were not affected even after the flexibility was evaluated. All the evaluation results were good, and are indicated “∘.” As indicated “∘” in the overall evaluation, the requirements of the reflect array were satisfied.

### Example 3

A 200 μm-thick polytetrafluoroethylene (PTFE) was used as the dielectric layer 12. 2 μm-thick Cu layers were formed on both sides of the dielectric layer 12 by plating as layers for forming the ground layer 11 and the element pattern layer 13, respectively. One of the Cu layers was etched to form the element pattern layer 13. The PTFE used had a dielectric constant of 2.06 and a dielectric loss tangent of 0.0007.

As shown in FIG. 15, in the simulation, the operating frequency was 28 GHz, λ0 was 10.7 mm, the thickness t of the dielectric layer 12 was 200 μm, the total thickness was 204 μm, the unit cell size was 3.785 mm, and the element length l was 3.1 mm or greater and 3.6 mm or less. The conditions of formulas (6) and (7) were satisfied, and as indicated by “∘” in the “phase shift examination,” desired reflection phase characteristics could be obtained.

Further, as shown in FIG. 16, a reflect array including four unit cells was formed and evaluated. As indicated “∘” in both the “reflection characteristics” and the “flexibility,” the evaluation results satisfied the required level. Further, as indicated by “∘” in the “characteristics after bending evaluation,” the reflection characteristics were not affected even after the flexibility was evaluated. All the evaluation results were good, and are indicated “∘.” As indicated “∘” in the overall evaluation, the requirements of the reflect array were satisfied.

### Example 4

A 100 μm-thick cycloolefin polymer was used as the dielectric layer 12. 2 μm-thick Cu layers were formed on both sides of the dielectric layer 12 by plating as layers for forming the ground layer 11 and the element pattern layer 13, respectively. One of the Cu layers was etched to form the element pattern layer 13. The cycloolefin polymer used had a dielectric constant of 2.32 and a dielectric loss tangent of 0.00039.

As shown in FIG. 15, in the simulation, the operating frequency was 28 GHZ, λ0 was 10.7 mm, the thickness t of the dielectric layer 12 was 100 μm, the total thickness was 104 μm, the unit cell size was 3.785 mm, and the element length l was 3.24 mm or greater and 3.53 mm or less. The conditions of formulas (6) and (7) were satisfied, and as indicated by “∘” in the “phase shift examination,” desired reflection phase characteristics could be obtained.

Further, as shown in FIG. 16, a reflect array including four unit cells was formed and evaluated. As indicated “∘” in both the “reflection characteristics” and the “flexibility,” the evaluation results satisfied the required level. Further, as indicated by “∘” in the “characteristics after bending evaluation,” the reflection characteristics were not affected even after the flexibility was evaluated. All the evaluation results were good, and are indicated “∘.” As indicated “∘” in the overall evaluation, the requirements of the reflect array were satisfied.

### Example 5

A 50 μm-thick polystyrene was used as the dielectric layer 12. 2 μm-thick Cu layers were formed on both sides of the dielectric layer 12 by plating as layers for forming the ground layer 11 and the element pattern layer 13, respectively. One of the Cu layers was etched to form the element pattern layer 13. The polystyrene used had a dielectric constant of 2.32 and a dielectric loss tangent of 0.00039.

As shown in FIG. 15, in the simulation, the operating frequency was 28 GHZ, λ0 was 10.7 mm, the thickness t of the dielectric layer 12 was 50 μm, the total thickness was 54 μm, the unit cell size was 3.785 mm, and the element length l was 3.45 mm. The conditions of formulas (6) and (7) were satisfied, and as indicated by “∘” in the “phase shift examination,” desired reflection phase characteristics could be obtained.

Further, as shown in FIG. 16, a reflect array including four unit cells was formed and evaluated. As indicated “∘” in both the “reflection characteristics” and the “flexibility,” the evaluation results satisfied the required level. Further, as indicated by “∘” in the “characteristics after bending evaluation,” the reflection characteristics were not affected even after the flexibility was evaluated. All the evaluation results were good, and are indicated “∘.” As indicated “∘” in the overall evaluation, the requirements of the reflect array were satisfied.

### Example 6

A 100 μm-thick PET was used as the dielectric layer 12. A 300 nm-thick Cu layer was formed on both sides of the dielectric layer 12 by vapor deposition as layers for forming the ground layer 11 and the element pattern layer 13, respectively. One of the Cu layers was etched to form the element pattern layer 13. The PET used had a dielectric constant of 3.03 and a dielectric loss tangent of 0.00476.

As shown in FIG. 15, in the simulation, the operating frequency was 28 GHZ, λ0 was 10.7 mm, the thickness t of the dielectric layer 12 was 100 μm, the total thickness was 100.6 μm, the unit cell size was 5.047 mm, and the element length l was 3.0 mm. The conditions of formulas (6) and (7) were satisfied, and as indicated by “∘” in the “phase shift examination,” desired reflection phase characteristics could be obtained.

Further, as shown in FIG. 16, a reflect array including four unit cells was formed and evaluated. As indicated “∘” in both the “reflection characteristics” and the “flexibility,” the evaluation results satisfied the required level. Further, as indicated by “∘” in the “characteristics after bending evaluation,” the reflection characteristics were not affected even after the flexibility was evaluated. All the evaluation results were good, and are indicated “∘.” As indicated “∘” in the overall evaluation, the requirements of the reflect array were satisfied.

### Example 7

A 100 μm-thick PET was used as the dielectric layer 12. A 300 nm-thick Al layer was formed on both sides of the dielectric layer 12 by vapor deposition as layers for forming the ground layer 11 and the element pattern layer 13, respectively. One of the Al layers was etched to form the element pattern layer 13. The PET used had a dielectric constant of 3.03 and a dielectric loss tangent of 0.00476.

As shown in FIG. 15, in the simulation, the operating frequency was 28 GHz, λ0 was 10.7 mm, the thickness t of the dielectric layer 12 was 100 μm, the total thickness was 100.6 μm, the unit cell size was 5.047 mm, and the element length l was 3.0 mm. The conditions of formulas (6) and (7) were satisfied, and as indicated by “∘” in the “phase shift examination,” desired reflection phase characteristics could be obtained.

Further, as shown in FIG. 16, a reflect array including three unit cells was formed and evaluated. As indicated “∘” in both the “reflection characteristics” and the “flexibility,” the evaluation results satisfied the required level. Further, as indicated by “∘” in the “characteristics after bending evaluation,” the reflection characteristics were not affected even after the flexibility was evaluated. All the evaluation results were good, and are indicated “∘.” As indicated “∘” in the overall evaluation, the requirements of the reflect array were satisfied.

### Example 8

A 50 μm-thick PET was used as the dielectric layer 12. 300 nm-thick Cu layers were formed on both sides of the dielectric layer 12 by plating as layers for forming the ground layer 11 and the element pattern layer 13, respectively. One of the Cu layers was etched to form the element pattern layer 13. The PET used had a dielectric constant of 3.03 and a dielectric loss tangent of 0.00476.

As shown in FIG. 15, in the simulation, the operating frequency was 60 GHZ, λ0 was 4.99 mm, the thickness t of the dielectric layer 12 was 50 μm, the total thickness was 50.6 μm, the unit cell size was 2.355 mm, and the element length l was 1.40 mm. The conditions of formulas (6) and (7) were satisfied, and as indicated by “∘” in the “phase shift examination,” desired reflection phase characteristics could be obtained.

Further, as shown in FIG. 16, a reflect array including three unit cells was formed and evaluated. As indicated “∘” in both the “reflection characteristics” and the “flexibility,” the evaluation results satisfied the required level. Further, as indicated by “∘” in the “characteristics after bending evaluation,” the reflection characteristics were not affected even after the flexibility was evaluated. All the evaluation results were good, and are indicated “∘.” As indicated “∘” in the overall evaluation, the requirements of the reflect array were satisfied.

### Example 9

A 200 μm-thick PET was used as the dielectric layer 12. 300 nm-thick Cu layers were formed on both sides of the dielectric layer 12 by plating as layers for forming the ground layer 11 and the element pattern layer 13, respectively. One of the Cu layers was etched to form the element pattern layer 13. The PET used had a dielectric constant of 3.03 and a dielectric loss tangent of 0.00476.

As shown in FIG. 15, in the simulation, the operating frequency was 60 GHZ, λ0 was 4.99 mm, the thickness t of the dielectric layer 12 was 200 μm, the total thickness was 200.6 μm, the unit cell size was 2.355 mm, and the element length l was 1.50 mm. The conditions of formulas (6) and (7) were satisfied, and as indicated by “∘” in the “phase shift examination,” desired reflection phase characteristics could be obtained.

Further, as shown in FIG. 16, a reflect array including three unit cells was formed and evaluated. As indicated “∘” in both the “reflection characteristics” and the “flexibility,” the evaluation results satisfied the required level. Further, as indicated by “∘” in the “characteristics after bending evaluation,” the reflection characteristics were not affected even after the flexibility was evaluated. All the evaluation results were good, and are indicated “∘.” As indicated “∘” in the overall evaluation, the requirements of the reflect array were satisfied.

### Example 10

A 20 μm-thick PET was used as the dielectric layer 12. 300 nm-thick Cu layers were formed on both sides of the dielectric layer 12 by plating as layers for forming the ground layer 11 and the element pattern layer 13, respectively. One of the Cu layers was etched to form the element pattern layer 13. The PET used had a dielectric constant of 3.03 and a dielectric loss tangent of 0.00476.

As shown in FIG. 15, in the simulation, the operating frequency was 100 GHz, λ0 was 2.99 mm, the thickness t of the dielectric layer 12 was 20 μm, the total thickness was 20.6 μm, the unit cell size was 1.413 mm, and the element length l was 0.90 mm. The conditions of formulas (6) and (7) were satisfied, and as indicated by “∘” in the “phase shift examination,” desired reflection phase characteristics could be obtained.

Further, as shown in FIG. 16, a reflect array including three unit cells was formed and evaluated. As indicated “∘” in both the “reflection characteristics” and the “flexibility,” the evaluation results satisfied the required level. Further, as indicated by “∘” in the “characteristics after bending evaluation,” the reflection characteristics were not affected even after the flexibility was evaluated. All the evaluation results were good, and are indicated “∘.” As indicated “∘” in the overall evaluation, the requirements of the reflect array were satisfied.

### Example 11

A 50 μm-thick PET was used as the dielectric layer 12. 300 nm-thick Cu layers were formed on both sides of the dielectric layer 12 by plating as layers for forming the ground layer 11 and the element pattern layer 13, respectively. One of the Cu layers was etched to form the element pattern layer 13. The PET used had a dielectric constant of 3.03 and a dielectric loss tangent of 0.00476.

As shown in FIG. 15, in the simulation, the operating frequency was 100 GHz, λ0 was 2.99 mm, the thickness t of the dielectric layer 12 was 50 μm, the total thickness was 50.6 μm, the unit cell size was 1.413 mm, and the element length l was 0.90 mm. The conditions of formulas (6) and (7) were satisfied, and as indicated by “∘” in the “phase shift examination,” desired reflection phase characteristics could be obtained.

Further, as shown in FIG. 16, a reflect array including three unit cells was formed and evaluated. As indicated “∘” in both the “reflection characteristics” and the “flexibility,” the evaluation results satisfied the required level. Further, as indicated by “∘” in the “characteristics after bending evaluation,” the reflection characteristics were not affected even after the flexibility was evaluated. All the evaluation results were good, and are indicated “∘.” As indicated “∘” in the overall evaluation, the requirements of the reflect array were satisfied.

### Comparative Example 1

A 300 μm-thick PET was used as the dielectric layer 12. 2 μm-thick Cu layers were formed on both sides of the dielectric layer 12 by plating as layers for forming the ground layer 11 and the element pattern layer 13, respectively. One of the Cu layers was etched to form the element pattern layer 13. The PET used had a dielectric constant of 3.03 and a dielectric loss tangent of 0.00476.

As shown in FIG. 15, in the simulation, the operating frequency was 28 GHz, λ0 was 10.7 mm, the thickness t of the dielectric layer 12 was 300 μm, the total thickness was 304 μm, the unit cell size was 5.047 mm, and the element length l was 3.50 mm. In the conditions included in formula (6), “1≥4.4t” was satisfied, but “0.001<t<0.25” was not satisfied. Further, the condition of formula (7) was satisfied. Further, as indicated by “x” in the “phase shift examination,” desired reflection phase characteristics could not be obtained.

Further, as shown in FIG. 16, since desired reflection phase characteristics could not be obtained in the reflection control region, a reflect array was not formed.

### Comparative Example 2

A 764 μm-thick fluororesin-impregnated glass cloth was used as the dielectric layer 12. 18 μm-thick Cu layers were formed on both sides of the dielectric layer 12 by plating as layers for forming the ground layer 11 and the element pattern layer 13, respectively. One of the Cu layers was etched to form the element pattern layer 13. The dielectric layer used had a dielectric constant of 2.6 and a dielectric loss tangent of 0.0025.

As shown in FIG. 15, in the simulation, the operating frequency was 28 GHZ, λ0 was 10.7 mm, the thickness t of the dielectric layer 12 was 764 μm, the total thickness was 800 μm, the unit cell size was 5.047 mm, and the element length l was 2.21 mm or greater and 3.31 mm or less. Neither the conditions of formulas (6) nor (7) was satisfied, and as indicated by “x” in the “phase shift examination,” desired reflection phase characteristics could not be obtained.

Further, as shown in FIG. 16, a reflect array including three unit cells was formed and evaluated. As indicated “∘” in the “reflection characteristics,” the required level was satisfied. However, as indicated by “x” in the “flexibility” and “characteristics after bending evaluation”, good evaluation results were not obtained. As indicated “x” in the overall evaluation, the requirements of the reflect array were not satisfied.

### Comparative Example 3

A 600 μm-thick PET was used as the dielectric layer 12. 2 μm-thick Cu layers were formed on both sides of the dielectric layer 12 by plating as layers for forming the ground layer 11 and the element pattern layer 13, respectively. One of the Cu layers was etched to form the element pattern layer 13. The PET used had a dielectric constant of 3.03 and a dielectric loss tangent of 0.00476.

As shown in FIG. 15, in the simulation, the operating frequency was 28 GHZ, λ0 was 10.7 mm, the thickness t of the dielectric layer 12 was 600 μm, the total thickness was 604 μm, the unit cell size was 5.047 mm, and the element length l was 3.0 mm. Regarding the conditions of formula (6), “1≥4.4t” was satisfied as indicated by “∘”, but “0.001<t<0.25” was not satisfied as indicated by “x”. Further, the condition of formula (7) was satisfied, and as indicated by “∘” in the “phase shift examination”, desired reflection phase characteristics could be obtained.

Further, as shown in FIG. 16, a reflect array including three unit cells was formed and evaluated. As indicated “∘” in the “reflection characteristics,” the required level was satisfied. However, as indicated by “x” in the “flexibility” and “characteristics after bending evaluation”, good evaluation results were not obtained. As indicated “x” in the overall evaluation, the requirements of the reflect array were not satisfied.

### Comparative Example 4

A 1,000 μm-thick PET was used as the dielectric layer 12. 2 μm-thick Cu layers were formed on both sides of the dielectric layer 12 by plating as layers for forming the ground layer 11 and the element pattern layer 13, respectively. One of the Cu layers was etched to form the element pattern layer 13. The PET used had a dielectric constant of 3.03 and a dielectric loss tangent of 0.00476.

As shown in FIG. 15, in the simulation, the operating frequency was 28 GHZ, λ0 was 10.7 mm, the thickness t of the dielectric layer 12 was 1,000 μm, the total thickness was 1,004 μm, the unit cell size was 5.047 mm, and the element length l was 2.5 mm. Regarding the conditions of formula (6), “1≥4.4t” was satisfied as indicated by “∘”, but “0.001<t<0.25” was not satisfied as indicated by “x”. Further, the condition of formula (7) was not satisfied, and as indicated by “x” in the “phase shift examination,” desired reflection phase characteristics could not be obtained.

Further, as shown in FIG. 16, since desired reflection phase characteristics could not be obtained in the reflection control region, a reflect array was not formed.

### Comparative Example 5

A 500 μm-thick PET was used as the dielectric layer 12. 2 μm-thick Cu layers were formed on both sides of the dielectric layer 12 by plating as layers for forming the ground layer 11 and the element pattern layer 13, respectively. One of the Cu layers was etched to form the element pattern layer 13. The PET used had a dielectric constant of 3.03 and a dielectric loss tangent of 0.00476.

As shown in FIG. 15, in the simulation, the operating frequency was 60 GHz, λ0 was 4.99 mm, the thickness t of the dielectric layer 12 was 500 μm, the total thickness was 504 μm, the unit cell size was 2.355 mm, and the element length l was 0.2 mm. Neither the conditions of formulas (6) nor (7) was satisfied. Further, as indicated by “x” in the “phase shift examination,” desired reflection phase characteristics could not be obtained.

Further, as shown in FIG. 16, since desired reflection phase characteristics could not be obtained in the reflection control region, a reflect array was not formed.

### Comparative Example 6

A 1,000 μm-thick PET was used as the dielectric layer 12. 2 μm-thick Cu layers were formed on both sides of the dielectric layer 12 by plating as layers for forming the ground layer 11 and the element pattern layer 13, respectively. One of the Cu layers was etched to form the element pattern layer 13. The PET used had a dielectric constant of 3.03 and a dielectric loss tangent of 0.00476.

As shown in FIG. 15, in the simulation, the operating frequency was 60 GHz, λ0 was 4.99 mm, the thickness t of the dielectric layer 12 was 1,000 μm, the total thickness was 1,004 μm, the unit cell size was 2.355 mm, and the element length l was 2 mm. Regarding the conditions of formula (6), “1≥4.4t” was satisfied as indicated by “∘”, but “0.001<t<0.25” was not satisfied as indicated by “x”. Further, the condition of formula (7) was not satisfied. As indicated “x” in the “phase shift examination,” desired reflection phase characteristics could not be obtained.

Further, as shown in FIG. 16, since desired reflection phase characteristics could not be obtained in the reflection control region, a reflect array was not formed.

### Comparative Example 7

A 250 μm-thick PET was used as the dielectric layer 12. 2 μm-thick Cu layers were formed on both sides of the dielectric layer 12 by plating as layers for forming the ground layer 11 and the element pattern layer 13, respectively. One of the Cu layers was etched to form the element pattern layer 13. The PET used had a dielectric constant of 3.03 and a dielectric loss tangent of 0.00476.

As shown in FIG. 15, in the simulation, the operating frequency was 100 GHz, λ0 was 2.99 mm, the thickness t of the dielectric layer 12 was 250 μm, the total thickness was 254 μm, the unit cell size was 1.413 mm, and the element length l was 0.08 mm. Neither the conditions of formulas (6) nor (7) was satisfied. Further, as indicated by “x” in the “phase shift examination,” desired reflection phase characteristics could not be obtained.

Further, as shown in FIG. 16, a reflect array was not formed. As indicated “x” in the “reflection characteristics,” the required level was not satisfied. As indicated “Δ” in the “flexibility,” same samples reached an acceptable level. As indicated “x” in the overall evaluation, the requirements of the reflect array were not satisfied.

### Comparative Example 8

A 200 μm-thick PET was used as the dielectric layer 12. 2 μm-thick Cu layers were formed on both sides of the dielectric layer 12 by plating as layers for forming the ground layer 11 and the element pattern layer 13, respectively. One of the Cu layers was etched to form the element pattern layer 13. The PET used had a dielectric constant of 3.03 and a dielectric loss tangent of 0.00476.

As shown in FIG. 15, in the simulation, the operating frequency was 100 GHz, λ0 was 2.99 mm, the thickness t of the dielectric layer 12 was 200 μm, the total thickness was 204 μm, the unit cell size was 1.413 mm, and the element length l was 0.015 mm. Regarding the conditions of formula (6), “1≥4.4t” was not satisfied as indicated by “x”, but “0.001<t<0.25” was satisfied as indicated by “∘”. Further, the condition of formula (7) was not satisfied. As indicated “x” in the “phase shift examination,” desired reflection phase characteristics could not be obtained.

Further, as shown in FIG. 16, a reflect array was not formed. As indicated “x” in the “reflection characteristics,” the required level was not satisfied. In addition, as indicated by “∘” in the “flexibility,” an acceptable level was satisfied. As indicated “x” in the overall evaluation, the requirements of the reflect array were not satisfied.

### Comparative Example 9

A 400 μm-thick PET was used as the dielectric layer 12. 2 μm-thick Cu layers were formed on both sides of the dielectric layer 12 by plating as layers for forming the ground layer 11 and the element pattern layer 13, respectively. One of the Cu layers was etched to form the element pattern layer 13. The PET used had a dielectric constant of 3.03 and a dielectric loss tangent of 0.00476.

As shown in FIG. 15, in the simulation, the operating frequency was 100 GHz, λ0 was 2.99 mm, the thickness t of the dielectric layer 12 was 400 μm, the total thickness was 404 μm, the unit cell size was 1.413 mm, and the element length l was 0.5 mm. Neither the conditions of formulas (6) nor (7) was satisfied. Further, as indicated by “x” in the “phase shift examination”, desired reflection phase characteristics could not be obtained.

Further, as shown in FIG. 16, since desired reflection phase characteristics could not be obtained in the reflection control region, a reflect array was not formed.

### Advantageous Effects

According to the present disclosure, when producing a reflect array having structures of a ground layer, a dielectric layer and an element pattern layer, the thickness of the dielectric layer is within the range defined by formula (6) or (7). This enables the reflection characteristics and flexibility required for a reflect array to be achieved while ensuring ease of production, making the reflect array thinner and lighter.

In addition, by simulating the structures of the ground layer, the dielectric layer and the element pattern layer in advance, it is possible to derive specific structures, such as the thickness (total thickness) of the reflect array, the unit cell size and the element width, that can achieve desired reflection phase characteristics.

Further, according to the present disclosure, the flexibility of the reflect array can be ensured so that the workability and light weight can be achieved when installing and replacing the reflect array.

The advantages of thinning the film are as follows.
Roll-to-roll production is possible, making it possible to produce reflectors having a large area. Further, production cost and time can be reduced.
Reduced use of etchant and waste treatment chemicals, shorter etching time, and environmental friendliness
Weight can be reduced during installation, reducing the burden on workers. Further, bonding to curved surfaces is possible.
Thin thickness allows for space saving.

In the reflection control region 10 of the present disclosure, the unit cells are arranged in one direction in the x axis direction, but the present disclosure is not limited to this case. The reflection control region 10 including the ground layer 11, the dielectric layer 12 and the element pattern layer 13 can be applied to the case where the unit cells are arranged in both the x and y axis directions.

### Fourth Embodiment

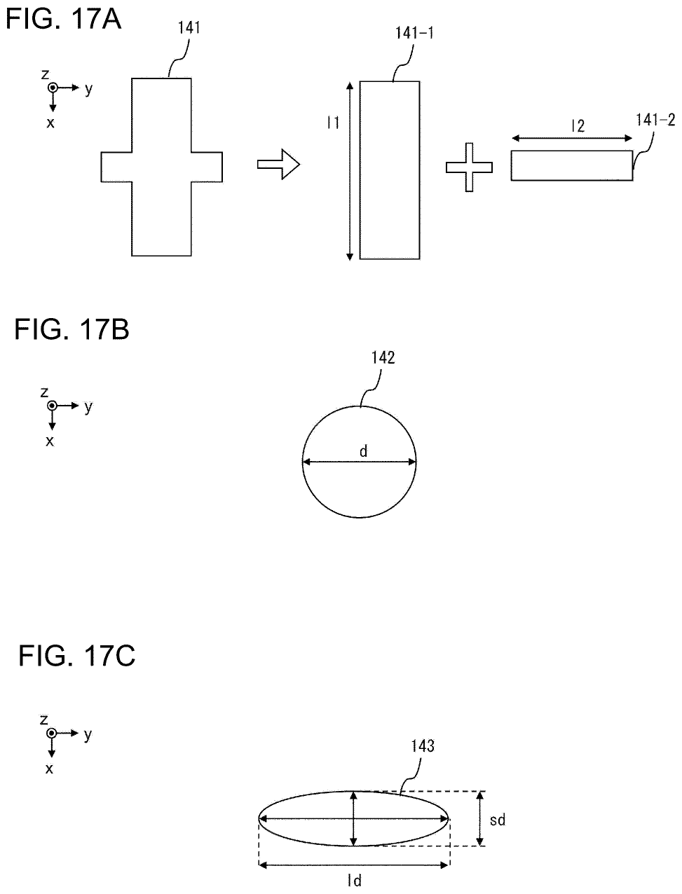

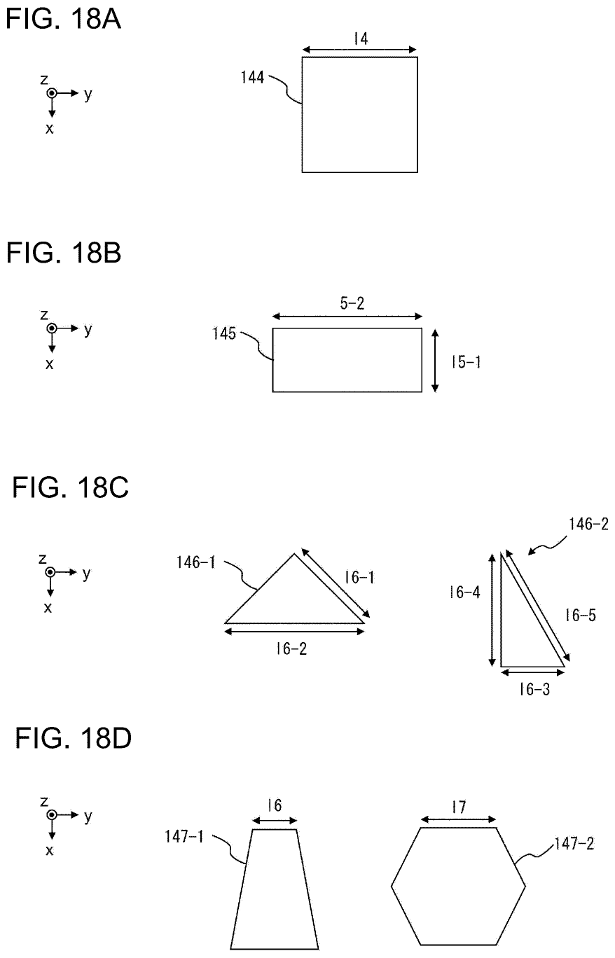

A fourth embodiment differs from the first embodiment in that the element patterns 14 include other shapes than the cross-patch. FIGS. 17A-17C and 18A-18D are diagrams illustrating element pattern shapes. The element pattern layer 13 can include the element patterns shown in FIGS. 17A-17C and 18A-18D, and setting of the element length l of the element pattern used as a parameter at the time of design will also be described.

In the following description, components that are the same or equivalent to those in the first embodiment described above are denoted by the same reference signs, and the description thereof will be simplified or omitted.

FIG. 17A is a diagram illustrating an element pattern 141. The element pattern 141 has a shape in which two rectangular patches having a rectangular shape intersect with each other, and rectangular patches 141-1 and 141-2 differ in size. The longitudinal length of the rectangular patch 141-1 is l1, and the longitudinal length of the rectangular patch 141-2 is l2. In this case, l2 is smaller than l1, and it is possible to use l2 for the element length l when applied to formula (6). If l2 satisfies formula (6), l1 also satisfies formula (6), and therefore it is preferred to use the element length l as the shorter of the lengths of the representative sides that define the shape of the element pattern, so that the element pattern as a whole satisfies formula (6).

FIG. 17B is a diagram illustrating an element pattern 142. The element pattern 142 has a circular shape with a diameter d. In this case, it is possible to use d for the element length l of the element pattern 142.

FIG. 17C is a diagram illustrating an element pattern 143. The element pattern 143 has an elliptical shape with a major axis ld and a minor axis sd. In this case, it is possible to use sd for the element length l of the element pattern 143.

FIG. 18A is a diagram illustrating an element pattern 144. The element pattern 144 has a square shape with a side length l4. In this case, it is possible to use l4 for the element length l of the element pattern 144.

FIG. 18B is a diagram illustrating an element pattern 145. The element pattern 145 has a rectangular shape, with the short side having a length l5-1 and the long side having a length l5-2. In this case, it is possible to use l5-1 for the element length l of the element pattern 145.

FIG. 18C is a diagram illustrating element patterns 146-1 and 146-2. The element pattern 146-1 has an isosceles triangle, with two sides of length l6-1 forming a right angle, and the side facing the right angle has a length l6-2. In this case, it is possible to use l6-1 for the element length l of the element pattern 146-1.

Further, the element pattern 146-2 is a right-angled triangle. The lengths of the sides are l6-3, l6-4 and l6-5, respectively. In this case, it is possible to use the shortest length l6-3 for the element length l of the element pattern 146-2.

FIG. 18D is a diagram illustrating element patterns 147-1 and 147-2. The element pattern 147-1 has a quadrangular shape, and the shortest side has a length l6. In this case, it is possible to use l6 for the element length l of the element pattern 147-1.

Further, the element pattern 147-2 has a hexagonal shape, and the shortest side has a length l7. In this case, it is possible to use l7 for the element length l of the element pattern 147-2.

Thus, when a polygon is used as an element pattern, the shortest side length can be used for the element length l of the element pattern.

As described above, the element length l can be set for each shape of the element pattern. When the element pattern has a polygonal shape, the shortest side length is used for the element length l, but the present disclosure is not limited thereto. For example, the length of the longest side can be set for the element length l.

In addition, the shape of the element pattern is not limited to that of the present disclosure. For example, the shapes of the element patterns shown in the present disclosure can be combined to obtain an element pattern having a desired shape.

### Other Embodiments

Possible aspects of the present invention will be described below, but are not limited thereto.

### (Aspect 1)

A reflect array including: a ground layer; a dielectric layer; and an element pattern layer having a plurality of element patterns, wherein
a thickness t (mm), which is a thickness of the dielectric layer, and an element length 1 (mm), which is a length of each of the plurality of element patterns, satisfy the following relational formula:

$$\begin{matrix}[ Math . 5 ] & \\ 1 \geq 4.4 \times t and 0.001 < t < 0.25 & ( 6 )\end{matrix}$$

### (Aspect 2)

The reflect array according to aspect 1, wherein a wavelength λ0 (mm), which is a wavelength at a design frequency, and a thickness t (mm), which is a thickness of the dielectric layer, satisfy the following relational formula:

$$\begin{matrix}[ Math . 6 ] & \\ 0.001 < t < 0.065 \times λ 0 & ( 7 )\end{matrix}$$

### (Aspect 3)

The reflect array according to aspect 1 or 2, wherein the ground layer has a surface resistance of 100Ω/□ or less.

### (Aspect 4)

The reflect array according to any one of aspects 1 to 3, wherein at least one of the ground layer and the element pattern layer is made of Cu or Al.

### (Aspect 5)

The reflect array according to aspect 4, wherein the at least one layer has a thickness of 1 μm or less.

### (Aspect 6)

The reflect array according to any one of aspects 1 to 5, wherein an element width w, which is a width of the element patterns, is 3 mm or less.

### (Aspect 7)

The reflect array according to any one of aspects 1 to 6, wherein desired reflection phase characteristics are obtained when the element width w, which is a width of the element pattern, is varied within a predetermined range.

### (Aspect 8)

The reflect array according to any one of aspects 1 to 7, further including an adhesion-enhancement layer.

### (Aspect 9)

The reflect array according to any one of aspects 1 to 8, further including a functional layer.

The embodiments of the present invention have been described, but the present invention is not limited to the above-mentioned embodiments, and various modifications can be made without departing from the spirit of the present invention.

### REFERENCE SIGNS LIST

1, 1a to 1x: Reflect array, 10: Reflection control region, 11: Ground layer, 12, 12a: Dielectric layer, 13: Element pattern layer, 14, 14a to 14d, 141 to 145, 146-1, 146-2, 147-1, 147-2: Element pattern, 15, 16, 19, 20: Adhesion-enhancement layer, 17: Functional layer, 18: Functional material

What is claimed is:

1. A reflect array comprising: a ground layer; a dielectric layer; and an element pattern layer having a plurality of element patterns, wherein
a thickness t (mm), which is a thickness of the dielectric layer, and an element length 1 (mm), which is a length of each of the plurality of element patterns, satisfy the following relational formula:
$$1 \geq 4.4 \times t and 0.001 < t < 0.25 \qquad ( 6 )$$

2. The reflect array according to claim 1, wherein
a wavelength λ0 (mm), which is a wavelength at a design frequency, and a thickness t (mm), which is a thickness of the dielectric layer, satisfy the following relational formula:
$$0.001 < t < 0.065 \times λ 0 \qquad ( 7 )$$

3. The reflect array according to claim 1, wherein
the ground layer has a surface resistance of 100Ω/□ or less.

4. The reflect array according to claim 1, wherein
at least one of the ground layer and the element pattern layer is made of Cu or Al.

5. The reflect array according to claim 4, wherein
the at least one layer has a thickness of 1 μm or less.

6. The reflect array according to claim 1, wherein
an element width w, which is a width of the element patterns, is 3 mm or less.

7. The reflect array according to claim 1, wherein
desired reflection phase characteristics are obtained when the element width w, which is a width of the element pattern, is varied within a predetermined range.

8. The reflect array according to claim 1, further comprising an adhesion-enhancement layer.

9. The reflect array according to claim 1, further comprising a functional layer.
